(19) United States
(12) Patent Application Publication
(10) Pub. No.: US 2021/0180391 A1
(43) Pub. Date: Jun. 17, 2021

(54) STORAGE SYSTEM

(71) Applicants: Martinus DIJKEMA, Lawrenceville, GA (US); Richard William MEIER, Jupiter, FL (US)

(72) Inventors: Martinus DIJKEMA, Lawrenceville, GA (US); Richard William MEIER, Jupiter, FL (US)

(21) Appl. No.: 17/177,060

(22) Filed: Feb. 16, 2021

Related U.S. Application Data
(63) Continuation of application No. 14/713,965, filed on May 15, 2015, now Pat. No. 10,094,161.
Application No. 14/713,965 is a continuation of application No. 14/713,968, filed on May 15, 2015, now Pat. No. 9,724,027.
Application No. 14/713,968 is a continuation-in-part of application No. 16/576,112, filed on Sep. 19, 2019, now Pat. No. 10,920,479.

(51) Int. Cl. E05G 1/026; E05B 65/00

(52) U.S. Cl. CPC E05G 1/026; E05B 65/0071; E05B 65/0075

(57) ABSTRACT

A storage system having an outer housing assembly including an elongated housing having a non-rotatable curved inner structure. A top assembly is attached to an upper end of the elongated housing, and a lower assembly is attached to a lower end of the elongated housing. An arcuate housing door rotates within the top assembly and the lower assembly concentrically about a longitudinal axis and partially within and adjacent to the non-rotatable curved inner structure. An upper end of the arcuate housing door rotates around a circular plate attached to the top assembly about the longitudinal axis. The arcuate housing door rotates between a closed position that prevents access to an internal compartment within the elongated housing and an open position that provides an access opening of approximately 180 degrees about the longitudinal axis into the internal compartment within the elongated housing.

### CROSS REFERENCE TO RELATED APPLICATIONS

This application is a Non-Provisional Application and claims priority to U.S. Non-Provisional application Ser. No. 16/576,112 filed Sep. 19, 2019; and claims priority to U.S. Non-Provisional application Ser. No. 14/713,965 filed May 15, 2015; and claims priority to U.S. Non-Provisional application Ser. No. 14/731,968 filed Jun. 5, 2015, the contents of all of which are hereby incorporated by reference herein in their entirety into this disclosure.

### BACKGROUND

### 1. Technical Field

The invention relates to a storage system for securely housing various valuable items, and in particular to providing a storage system having a rotatable door with a locking mechanism to prevent rotation of the rotatable door from a locked to an unlocked position into which valuable items may be stored.

### 2. Description of the Related Art

Gun and jewelry safes currently come in a variety of different sizes and shapes. Current gun safes are typically in the form of an upright, rectangular, metal box that include a rectangular door on the front of the box. Locking mechanisms used with these safes typically include numerous cylindrical metal bolts that slide into corresponding circular cutouts that are located contemporaneously close to the safe's door as the door is locked. Likewise, these conventional safes are cumbersome to use as the access door opening to insert and retrieve weapons from is narrow and oftentimes difficult to handle weapons there-through. Once open, withdrawing the various weapons from the safe in a quick manner is difficult and impossible with conventional designs.

Consequently, there is a need for a storage system with an improved locking mechanism having a large access door to secure various items, such as various weapons, their ammunition, magazines, and the like. Likewise, there is a need to be able to withdraw these various items from a safe in a quick and easy many.

### SUMMARY

An object of the present invention is to provide a storage system having an outer housing assembly including an elongated housing having a non-rotatable curved inner structure. A top assembly is attached to an upper end of the elongated housing, and a lower assembly is attached to a lower end of the elongated housing. An arcuate housing door rotates within the top assembly and the lower assembly concentrically about a longitudinal axis and partially within and adjacent to the non-rotatable curved inner structure. An upper end of the arcuate housing door rotates around a circular plate attached to the top assembly about the longitudinal axis. The arcuate housing door rotates between a closed position that prevents access to an internal compartment within the elongated housing, and an open position that provides an access opening of approximately 180 degrees about the longitudinal axis into the internal compartment within the elongated housing.

A rack assembly is disposed within the internal compartment and is capable of extending from the internal compartment along a track when the arcuate housing door is open. In the extended position, the rack assembly can also rotate to provide access to the items stored on the rack assembly.

These and other objects, features, and/or advantages may accrue from various aspects of embodiments of the present invention, as described in more detail below.

### BRIEF DESCRIPTION OF THE DRAWINGS

Various exemplary embodiments will be described in detail, wherein like reference numerals refer to identical or similar components or steps, with reference to the following figures, wherein:

FIG. 1 illustrates an exemplary a weapons storage system in a closed locked position in accordance with this invention.

FIG. 2 depicts the weapons storage system in an unlocked position.

FIG. 3 shows the rotatable housing and weapons cassette having a weapon secured within the weapons cassette.

FIG. 4 illustrates the weapons storage system in a partial open position.

FIG. 5 depicts the weapons storage system in an unlocked open position.

FIG. 6 shows a front view of the weapons storage system in an unlocked open position having various weapons secured to the weapons cassette.

FIG. 7 illustrates the weapons cassette removed from the weapons storage system.

FIGS. 8-9 depict the weapons cassette placed into a transfer carrying case.

FIG. 10 shows an upper rear perspective view of the weapons storage system and mounting system.

FIG. 11 illustrates an upper front perspective view of the weapons storage system.

FIG. 12 depicts a lower perspective view of the weapons storage system in an unlocked open position.

FIG. 13 shows a cross section view of the top assembly and the handle assembly.

FIG. 14 depicts a side view of the top assembly and the handle assembly.

FIG. 15 illustrates an exploded perspective view of the top assembly and the handle assembly.

FIG. 16 depicts a top view of the top assembly and the handle assembly.

FIG. 17 shows a lower perspective view of the top assembly of the weapons storage system.

FIG. 18 depicts a side view of the top assembly, the handle assembly and the weapons cassette attached thereto.

FIG. 19 illustrates a cross section view of the lower assembly and lower locking mechanism therein.

FIG. 20 shows an exploded view of the lower assembly and lower locking mechanism therein.

FIG. 21 depicts a top view of the lower locking mechanism in a locked closed position.

FIG. 22 illustrates a top view of the lower locking mechanism in an unlocked open position.

FIG. 23 shows an upper perspective view of the lower locking mechanism in a locked closed position.

FIG. 24 depicts an upper exploded perspective view of the lower locking mechanism in a locked closed position.

FIG. 25 illustrates a side view of the lower locking mechanism in a locked closed position.

FIG. 26 shows the barrel locking mechanism.

FIG. 27 shows the barrel locking mechanism attached to the weapons cassette.

FIG. 28 shows the barrel locking mechanism securing a barrel of a weapon.

FIG. 29 shows the barrel locking mechanism securing a rifle to the weapons cassette.

FIG. 30 shows retractable feet adapted for use with the weapons cassette.

FIG. 31 shows an enlarged view of the weapons cassette including a pair of retractable handles.

FIG. 32 depicts an exemplary wiring conductor extending from the keypad to the lower locking mechanism.

FIG. 33 is a perspective view of an exemplary second embodiment for a storage system according to this subject disclosure.

FIG. 34 is a front view of the storage system in a closed position.

FIG. 35 is a front view of the storage system in an open position.

FIG. 36 is a front view of the storage system embodied as a weapons storage system in an open position.

FIG. 37 is a lower perspective view of a rotatable housing and locking mechanism.

FIG. 38 is an upper perspective view of a rotatable housing and the locking mechanism.

FIG. 39 is a lower perspective view of the locking mechanism.

FIG. 40 is an upper perspective view of the locking mechanism.

FIG. 41 is an upper perspective view of an inside of an end cap in the lower assembly.

FIG. 42 is an upper perspective view of an inside of an end cap in the lower assembly with an attached locking mechanism.

FIG. 43 is an upper perspective view of a ball screw.

FIG. 44 is an upper perspective view of a ball screw cap.

FIG. 45 is an exploded view of A in FIG. 44 of an adjustable leveler assembly.

FIG. 46 is a lower perspective view of an outside of an end cap with an adjustable base plate in the lower assembly.

FIG. 47 is a lower perspective view of an end cap without the adjustable base plate in the lower assembly.

FIG. 48 is an upper perspective view of a locking mechanism without a bridge plate.

FIG. 49 is an upper perspective view of the locking mechanism without a bridge plate and a sear plate.

FIG. 50 is a top view of the locking mechanism in a locked position.

FIG. 51 is a top view of the locking mechanism in an unlocked position.

FIG. 52 is an upper perspective view of the storage system with a rack assembly in an extended position.

FIG. 52 is a first upper perspective view of the storage system with a rack assembly in an extended position.

FIG. 53 is a second upper perspective view of the storage system with a rack assembly in an extended position.

FIG. 54 is an upper perspective view of the storage system with shelves in an extended position.

FIG. 55 is an upper perspective view of the rack assembly.

FIG. 56 is a top view of the upper track in the rack assembly in an extended position without shelves.

FIG. 57 is a top view of the upper track in the rack assembly in an extended position with shelves.

FIG. 58 is a bottom view of the lower track in the rack assembly in an extended position without shelves.

FIG. 59 is a bottom view of the lower track in the rack assembly in an extended position with shelves.

### DETAILED DESCRIPTION

Particular embodiments of the present invention will now be described in greater detail with reference to the figures.

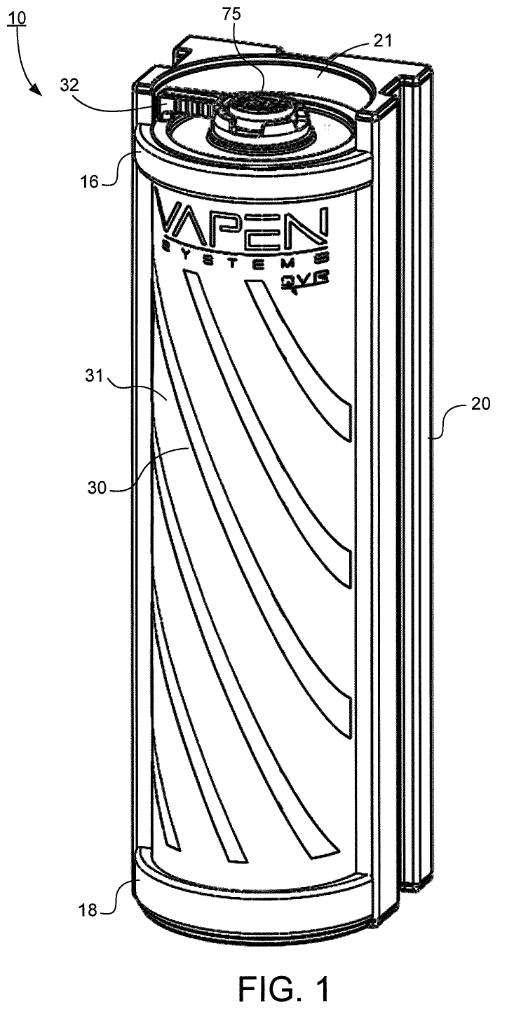

FIG. 1 illustrates an exemplary weapons storage system 10 according to this subject disclosure. Various advantages will be described below by the construction of the weapons storage system 10. The construction of the weapons storage system 10 provides for a large 180 degree access opening to an internal compartment in an unlocked open position. A locking mechanism may be positioned in a remote, hard to access, location within a lower assembly of the weapons storage system 10. A code input receiver, such as a keypad may be positioned atypically distant from the locking mechanism further ensuring the inability to break into the weapons storage system 10. Another advantage of the weapons storage system 10 is the ability to rapidly access weapons stored therein and to be able to quickly remove a weapons cassette from within the weapons storage system 10 and quickly move it to a remote location.

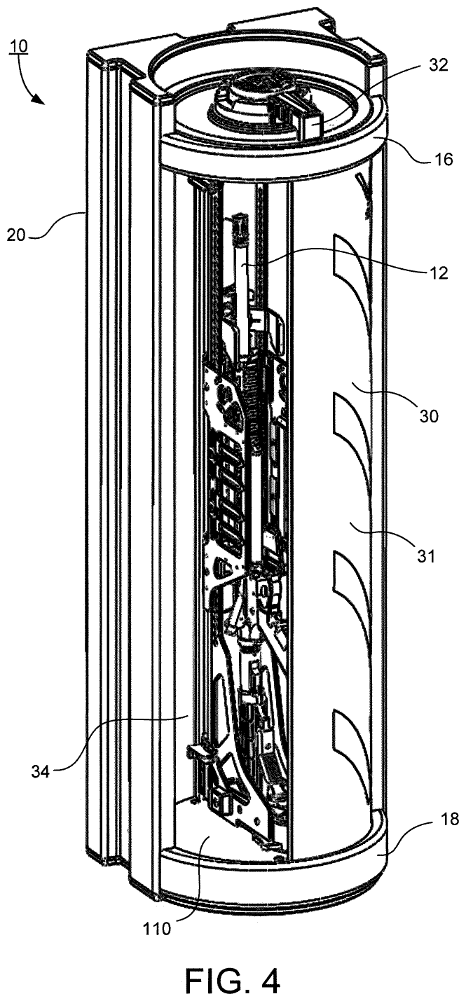

The weapons storage system 10 has an elongated upright tall profile. The weapons storage system 10 may have a rectangular outer base housing 20 bounded by a lower assembly 18 and a top assembly 16. The outer base housing 20 has an elongated curved inner structure 21. The rectangular outer base housing 20, the lower assembly 18 and the top assembly 16 all partially encase an integrated cylindrical shaped and an elongated upright inner secure rotatable housing 30. The inner secure rotatable housing 30 is rotated between an open position and a closed position by a handle 32 provided in the top assembly 16 at an upper end of the rotatable housing 30 to enable access to a weapons cassette 45 securing various weapons 12 stored in an interior compartment 34 as shown in FIG. 4. As will be discussed in more detail later, a key pad 75 is electronically connected to a locking mechanism 80 located in the lower assembly 18 and is adapted to lock and unlock the rotation of the rotatable housing 30.

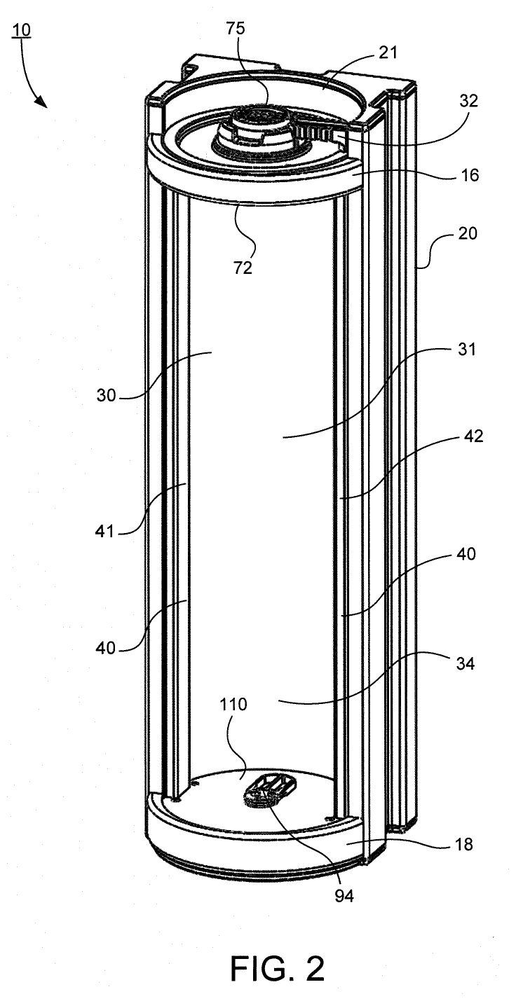

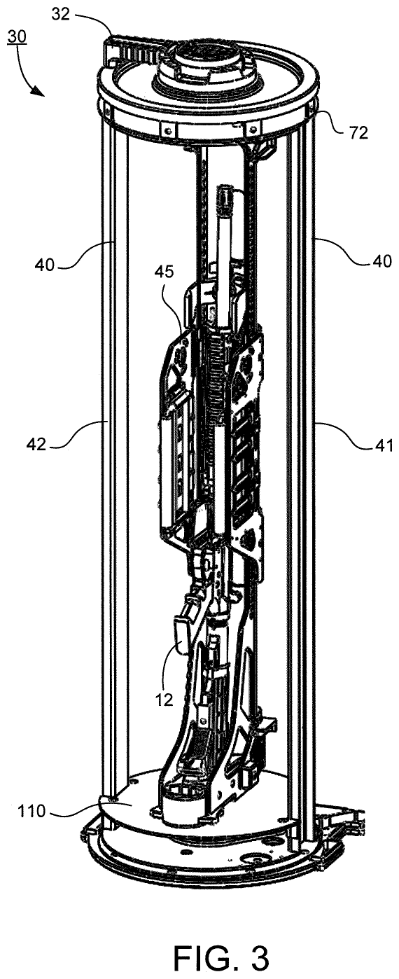

FIGS. 2 and 3 show the inner secure rotatable housing 30 is constructed in a tubular vertical shape and includes a pair of vertical frame members 40 having a first vertical frame member 41, and a second vertical frame member 42 opposite the first vertical frame member 41. The first vertical frame member 41 and second vertical frame member 42 are attached between the upper door plate 72 and the lower floor plate 110, all of which rotate together as an integrated unit being a part of the rotatable housing 30. The weapons cassette 45 securing the weapons 12 is fixed and the rotatable housing 30 rotates around the weapons cassette 45. It is to be understood that the weapons cassette 45 securing the weapons 12 can also be constructed to rotate with the rotatable housing 30.

In FIG. 2, the inner secure rotatable housing 30 has been rotated approximately 180 degrees from the first locked or closed position shown in FIG. 1. The rotating door 31 of the rotatable housing 30 has been rotated and lies adjacent to the inner curved surface 21 of the rectangular outer base housing 20. The inner curved surface 21 may take a variety of different shapes, such as for example a u-shaped curve, a cylindrical curve or some other curve with a predetermined radius of curvature. The inner curved surface 21 is provided to rotationally mate concentrically with the rotatable housing 30 adjacent to the inner curved surface 21.

The interior compartment 34 within the rotatable housing 30 is constructed as an elongated cylindrical housing. The door 31 is integrated with the rotatable housing 30 and is attached between the vertical frame members 40 and the upper door plate 72 and the lower floor plate 110, and rotates between a first locked closed position (FIG. 1) and a second open unlocked position (FIG. 2).

In FIG. 3, although one weapons cassette 45 is shown provided, it is to be understood that the overall size of the weapon storage system 10 may be sufficiently large enough to house more than one weapons cassette 45. That is, a diameter of the internal compartment 34 of the weapon storage system 10 may be large enough to house two, three or sufficiently more weapons cassettes 45 within the weapon storage system 10.

FIG. 4 shows the rotatable housing 30 rotated approximately midway between the first closed position as shown in FIG. 1 and the second open position as shown in FIG. 2. In the second open position (such as shown in FIG. 2), the door 31 is concentrically rotated into an open position allowing a wide access opening into the interior compartment 34. The door 31 is positioned at the rear of the interior compartment 34 adjacent to the inner curved surface 21 of the outer base housing 20. In the closed position (such as shown in FIG. 1), the door 31 is concentrically rotated into a secure closed position at the front of the interior compartment 34 closing off access to the storage of weapons 12 within the interior compartment 34.

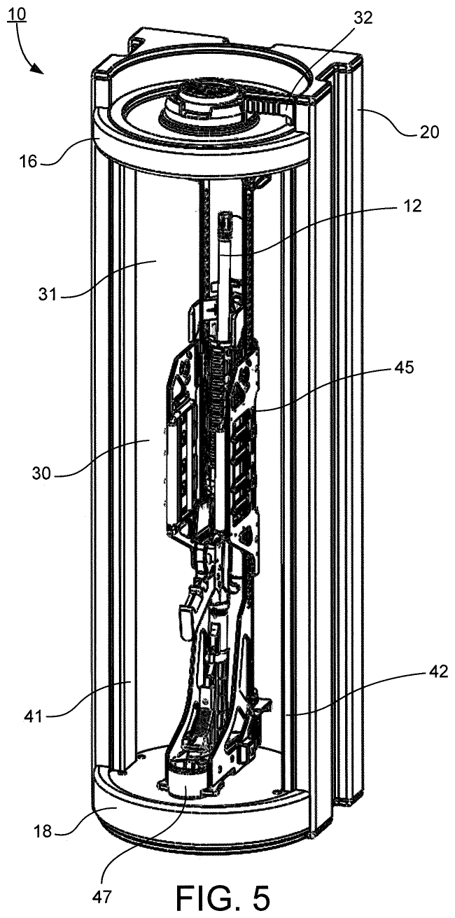

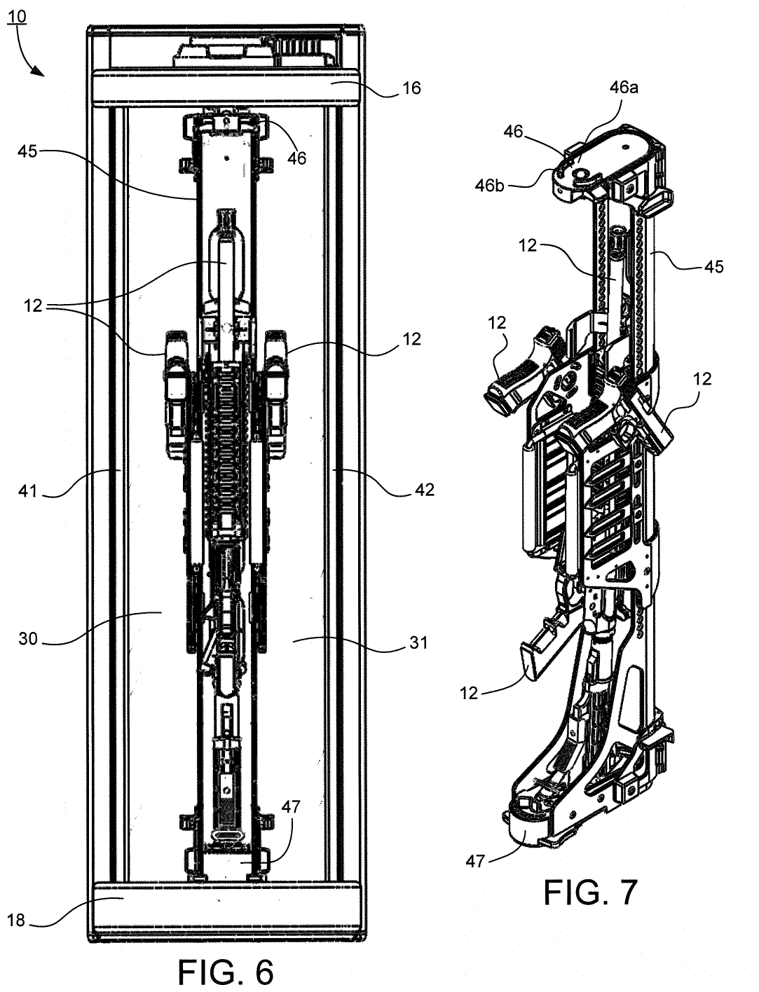

FIG. 4-6 shows the weapons cassette 45 securely mounted within the interior compartment 34 of the weapons storage system 10. As shown, the interior compartment 34 houses the weapons cassette 45. The weapons cassette 45 is also adapted to store and secure various weapons such as a rifle, a hand gun, a high voltage weapon, a baton, magazines, a knife, flashlight, tear gas, handcuffs, vest, pepper spray, ammunition and other weapons and equipment suitable for law enforcement use.

FIG. 7 illustrates the quick disconnect construction of the weapons cassette 45 removed from within the rotatable housing 30. An advantage of this weapons storage system 10 is the ability of the entire weapons cassette 45 to be quickly and easily released from its storage position inside of the interior compartment 34 of the weapons storage system 10. As will be described in more detail later, a locking mechanism 80 disposed in the lower assembly 18 is provided to prevent the rotatable housing 30 and the rotatable door 31 to permit access to the weapons 12 from being rotated into an open position to maintain the security of the weapons cassette 45 within the weapons storage system 10.

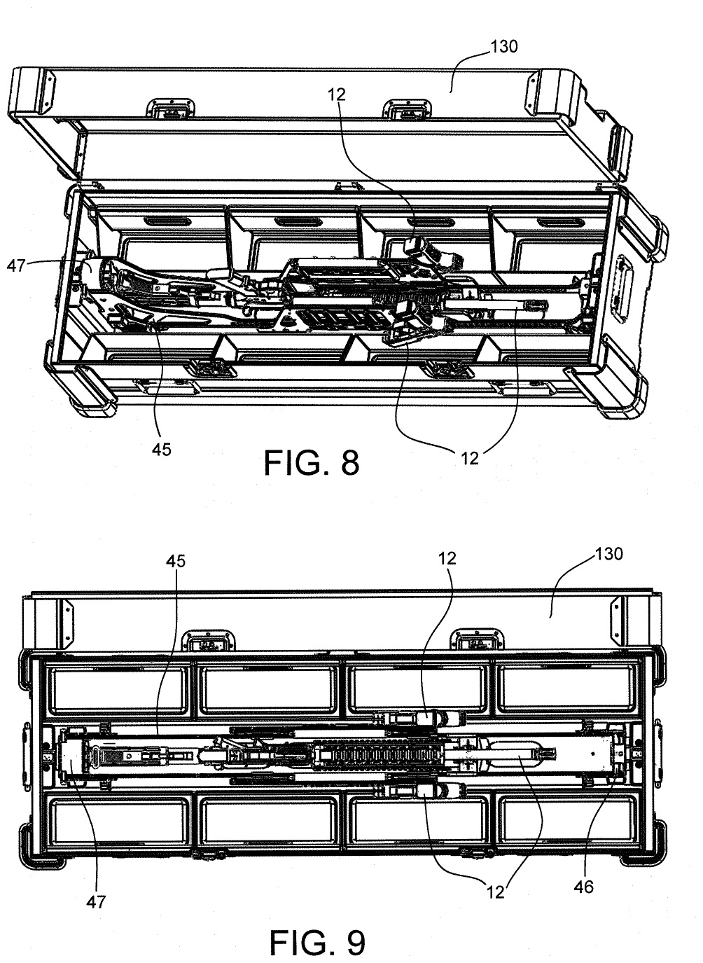

FIGS. 8-9 show a transfer carrier case 130 into which the weapons cassette 45 may be placed and transferred to another location in a concealed manner. The transfer carrier case 130 may take a variety of different sizes and/or shapes. In this exemplary embodiment, the transfer carrier case 130 is configured like a suitcase as a rectangular compartment carrying case with a pivoting lid. The transfer carrier case 130 may be adapted to securely receive the weapons cassette 45 within the transfer carrier case 130 and transport the weapons cassette 45 from the weapons storage system 10 to a remote location. The transfer carrier case 130 may also include a mounting assembly adapted to receive the upper weapons cassette mount 46 and the lower weapons cassette mount 47 to secure the weapons cassette 45 within the transfer carrier case 130.

For example, a weapons storage system 10 may be securely located in a police station. A police vehicle may be provided with a mating mounting system adapted to receive the entire weapons cassette 45. As such, an authorized user (such as a police officer) may remove the weapons cassette 45 containing the various weapons 12 (rifle, handgun, stun gun, etc) and ammunition from its secure location in the weapons storage system 10 and transport it from within the police station to the police vehicle in the transfer carrier case 130.

Alternatively, the police vehicle may be adapted to receive and lock the entire carrier case 130 with the weapons cassette 45 disposed therein into the vehicle at a predetermined location, such as in the trunk of the vehicle. The trunk of the vehicle may be equipped with a mating mounting system adapted to receive the entire carrier case 130.

In another use example, once the user arrives at the police vehicle, she may easily remove the weapons cassette 45 from the transfer carrier case 130 and securely install it to a mating mounting system adapted to engage the upper weapons cassette mount 46 and the lower weapons cassette mount 47 within the police vehicle. The advantage of the self contained weapons cassette 45 is that the police officer does not have to independently retrieve numerous weapons and ammunition and various pieces of equipment required for their job and carry them separately from the station to the police vehicle. This process can be cumbersome and time consuming. The weapons cassette 45 acts as a self contained unit capable of carrying all of the various pieces of equipment all together attached to the weapons cassette 45 as a single secure unit.

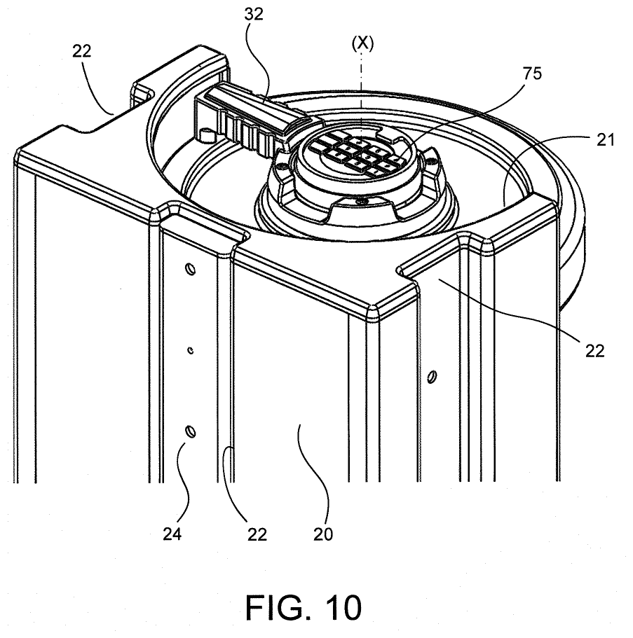

In FIG. 10, returning to the construction of the weapons storage system 10, a rear view of the rectangular outer base housing 20 is shown. Various mounting channels 22 can be provided about the various surfaces of the outer base housing 20 for securing the weapons safe 10 to another surface, such as a wall. A mounting bracket such as a mating elongated rigid bar 24 can be securely anchored to the wall or other surface by various threaded secure fasteners. The channel 22 can be constructed and aligned with the elongated rigid bar 24 for securing to the wall or surface. The weapons safe storage system 10 can be mounted to the surface upon which it is resting, such as a floor and/or any other suitable surface.

As shown from this angle, the handle 32 is secured to a center axis (X) that it rotates around and extends radially outward therefrom. The rectangular outer base housing 20 includes the curved interior surface 21 adapted to receive the secure the rotatable housing 30. The handle 32 rotates around the center axis (X) and has enough space provided between an end of the handle 32 and the inner curved interior surface 21 for rotation between the first closed position and the second open position.

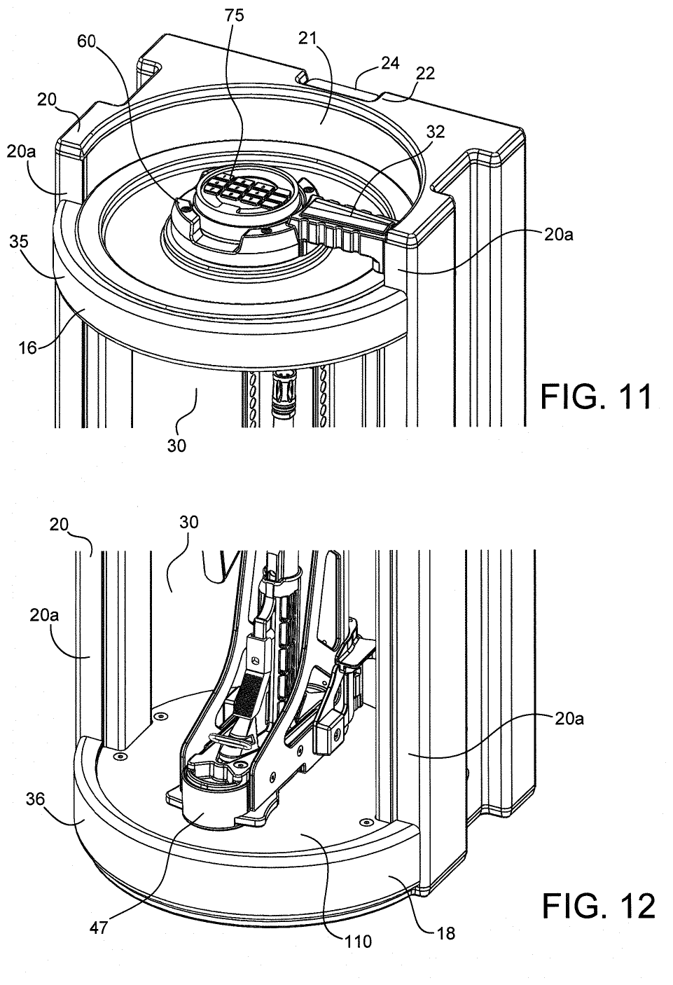

FIGS. 11-12 depict upper perspective views of the top assembly 16 and the lower assembly 18 in the weapons storage system 10. FIG. 11 shows an upper circular cap 35 provided at the top assembly 16 upper end of the secure rotatable housing 30. A lower circular cap 36 is shown in FIG. 12 and is provided at the lower assembly 18 lower end of the secure rotatable housing 30.

The upper circular cap 35 may be semicircular in shape and may be attached to a front face 20a of the base housing 20. Alternatively, the upper circular cap 35 may be circular and may be recessed and securely attached within a semicircular channel (not shown) provided in the front face 20a and inner curved surface 21 of the upper end of the base housing 20. The upper circular cap 35 covers and prevents access to the interior compartment within the top assembly 16 that houses the handle assembly 60. Various constructions for the upper circular cap 35 are possible.

Likewise, the lower circular cap 36 may be semicircular in shape and may attach to the front face 20a of the base housing 20. Alternatively, the lower circular cap 36 may be circular and may be recessed and securely attached within a semicircular channel (not shown) provided in the front face 20a and inner curved surface 21 at the lower end of the base housing 20. The lower circular cap 36 covers and prevents access to the interior compartment within the lower assembly 18 that houses the lower locking mechanism 80. Various constructions for the lower circular cap 36 are possible.

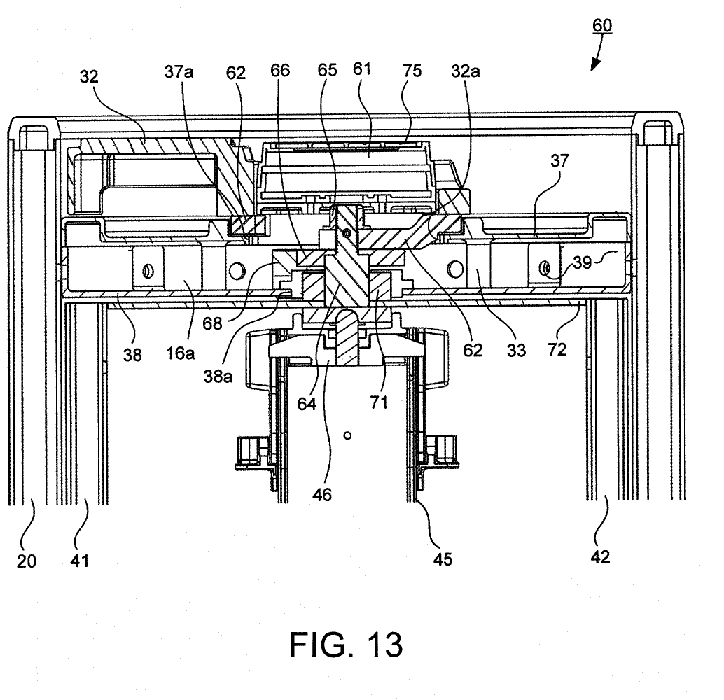

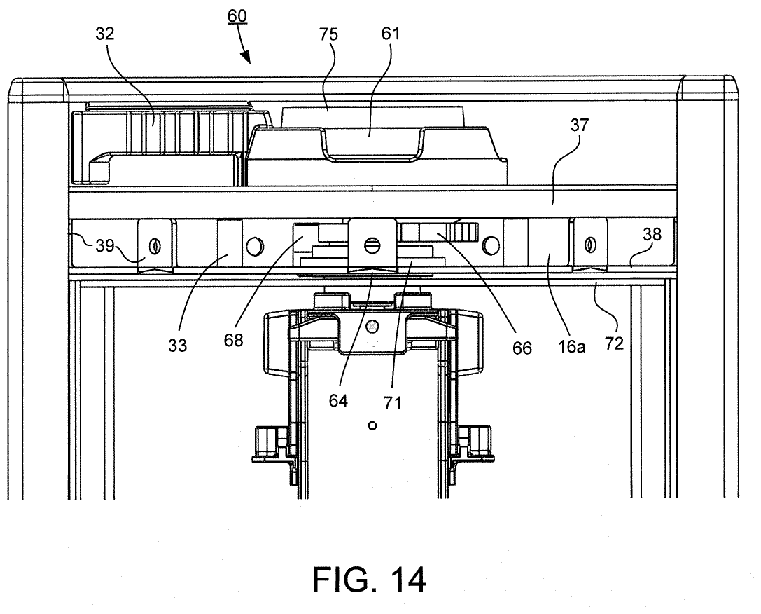

FIGS. 13-15 show a cross section, a side view and exploded view of the handle assembly 60. The top assembly 16 is located above the interior compartment 34 of the weapon storage system 10. The top assembly 16 includes an interior space 16a defined between an upper inner circular cap 37 and an upper inner base cap 38. The upper inner circular cap 37 may be attached to the upper inner base cap 38 in a variety of different ways. Various fastener projections 33 may extend from the upper inner circular cap 37 adapted to receive various fasteners to secure the upper inner base cap 38 to the upper inner circular cap 37. The upper inner circular cap 37 and the upper inner base cap 38 are fixed to the rectangular outer base housing 20.

The upper inner base cap 38 may be secured to the upper outer circular cap 35 and/or the rectangular outer base housing 20 in a variety of different ways. For example, and as shown, various tabs 39 may extend from the upper inner base cap 38 having a fastener hole adapted to receive a fastener to secure the upper inner base cap 38 to the upper outer circular cap 35 and/or the rectangular outer base housing 20.

The weapons storage system 10 includes an upper inner circular cap 37 and the upper inner base cap 38. An upper surface of the upper inner circular cap 37 may be constructed to include an upper aperture 37a in the center having a shoulder and a concentric channel encircling the shoulder surrounding the upper aperture. Likewise, the upper inner base cap 38 may also have a lower aperture 38a substantially aligned with and below the upper aperture 37a in the upper inner circular cap 37. The upper aperture 37a and the lower aperture 38a adapted to receive the various components of the handle assembly 60.

In construction, the handle 32 has a central opening 32a adapted to receive a handle cap 61 therein. The central opening of the handle 32 is positioned above the upper aperture 37a in the upper inner circular cap 37 and allowed to rotate around the upper aperture 37a. The handle 32 is attached to a support ring 62 with an internal tongue 62a having an aperture 62b and a recessed groove 62c bisecting the aperture 62b.

The support ring 62 is fastened to an upper main shaft 64 having an extending cross member 64a that mates with the recessed groove 62c in the internal tongue 62a of the support ring 62. An upper stop plate 66 is located on the upper main shaft 64 below the internal tongue 62a of the support ring 62. The upper stop plate 66 rotates a predetermined rotational distance between a first position and a second position defined by a position of an upper stop shaft 68. As shown, the upper stop plate 66 has a central substantially circular base with a pair of arms 66a, 66b that extend therefrom.

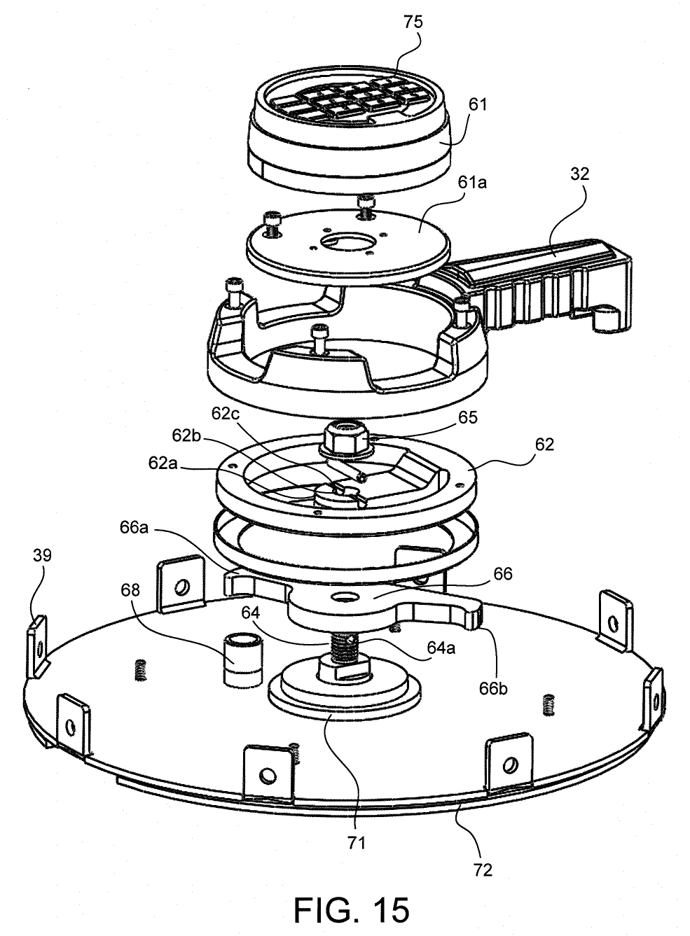

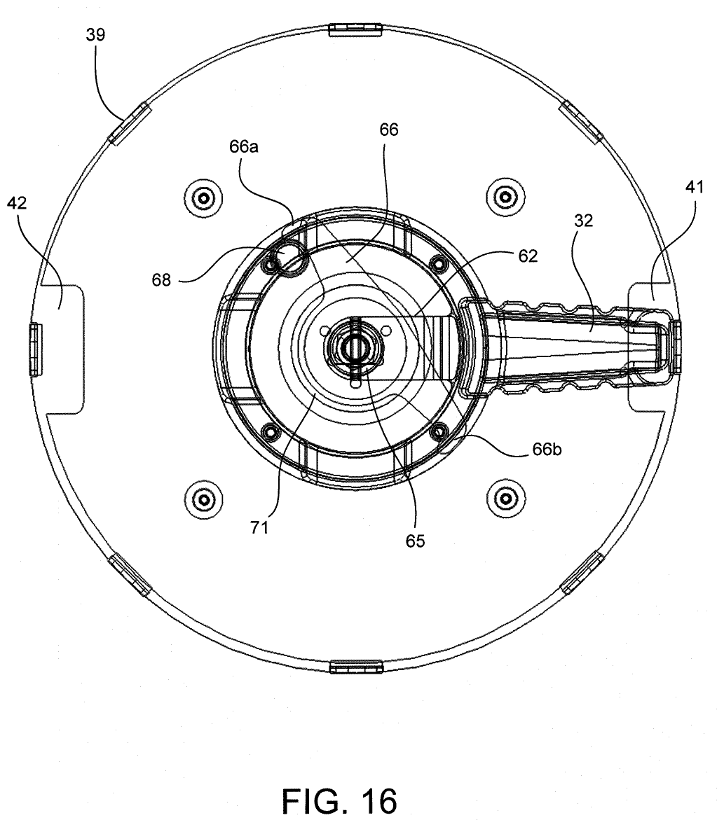

FIGS. 15-16 illustrates the first position (such as in a closed position), in which a first arm 66a engages the upper stop shaft 68 at a first orientation. In a second position (such as in an open position), a second arm 66b engages the upper stop shaft 68 at a second orientation. The upper stop shaft 68 defines the boundaries between which the handle assembly may rotate. One example may be a 180 degree turn between a first and a second position to define an open and a closed position. However, it is to be understood that the rotation degree can be varied according to this subject disclosure.

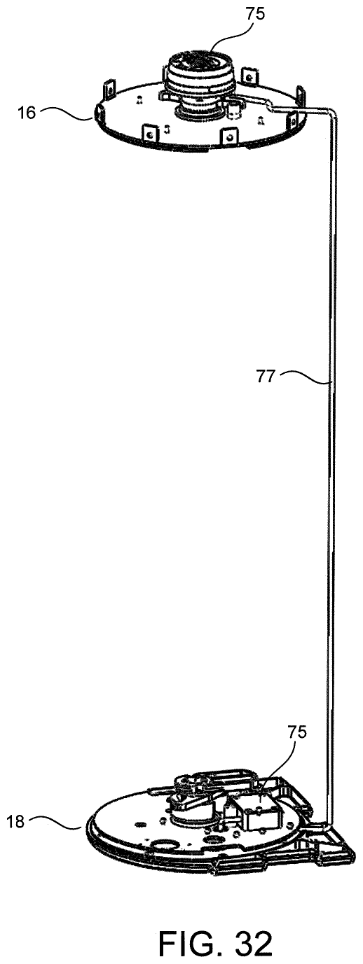

An upper bushing 71 is located on the upper main shaft 64 just below the upper stop plate 66. The upper bushing 71 is positioned between the upper main shaft 64 and an upper door plate 72 so that the handle assembly 60 may rotate the upper door plate 72 through the fixed top portion defined by the upper inner circular cap 37 and the upper inner base cap 38 that is fixed to the upper outer circular cap 35 and/or the rectangular outer base housing 20. The keypad 75 is disposed within a central portion of the handle 32. Circuitry for the keypad 75 may be embodied in an interior space between the handle cap 61 and a lower handle cap base cover 61a. As shown and described later in FIG. 32, a conductor 77 may extend from the circuitry of the keypad 75 to the lower locking mechanism 80. The various components are rotationally fixed between the handle 32 and the upper door plate 72 by a nut fastener 65 threadedly attached to an upper end of the upper main shaft 64.

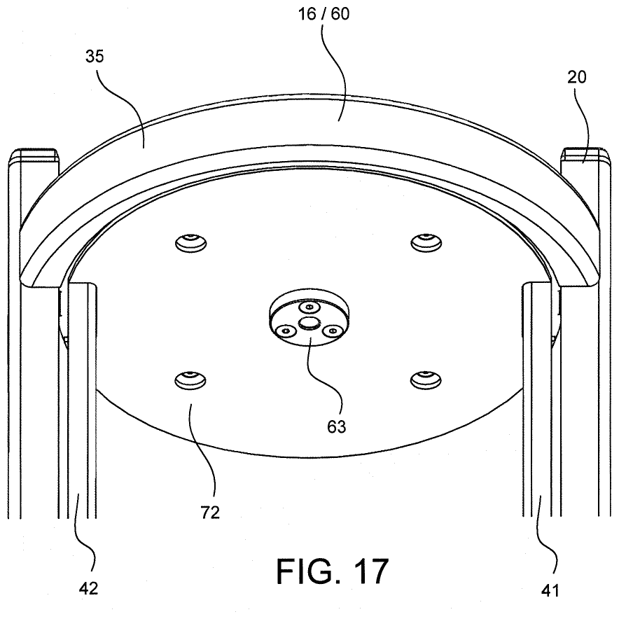

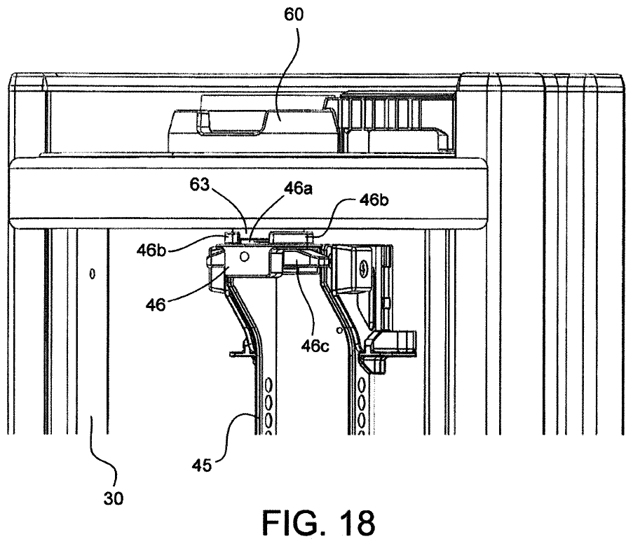

FIG. 17 shows the top assembly 16 including an upper locking mount 63 provided just below the upper door plate 72 adapted to be connected to the upper weapons cassette mount 46. FIG. 18 shows a side view of the handle assembly 60 connected through the upper locking mount 63 to the upper weapons cassette mount 46 attached to the weapons cassette 45. In operation, the weapons cassette 45 may be fixed and may not rotate as the handle assembly 60 and the rotatable housing 30 rotate together between an open position and a closed position. Alternatively, the weapons cassette 45 may be adapted to rotate with the rotation of the handle assembly 60 and the rotatable housing 30 as they rotate together between an open position and a closed position.

The upper weapons cassette mount 46 is positioned at the upper end of the weapons cassette 45 and is adapted to engage and lock onto the upper locking mount 63 attached to the top assembly 16 and the handle assembly 60.

FIG. 18 shows the upper weapons cassette mount 46 of the weapons cassette 45 having a receiving cup portion 46a (as shown in FIG. 7) with an outer guide 46b portion adapted to receive and align the upper locking mount 63 within the outer guides 46b. A pair of release levers 46c are integrated into the upper weapons cassette mount 46 and function as latch release levers to release the upper locking mount 46 from the upper locking mount 63 in a quick manner when the release levers 46c are depressed.

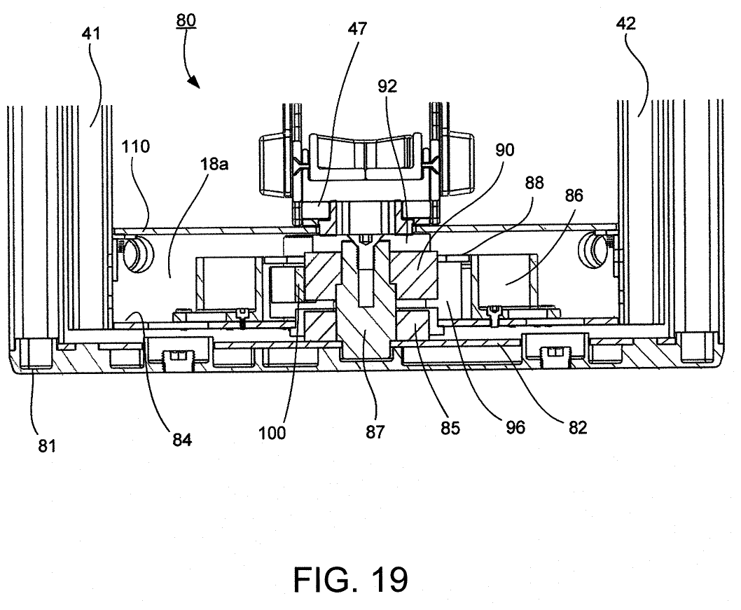

FIG. 19 shows a cross section view of the lower locking mechanism 80 in the lower assembly 18. The lower assembly 18 below the interior compartment 34 of the weapon storage system 10 includes the outer lower circular cap 36 as shown in FIG. 2. The lower assembly 18 includes an interior space 18a defined between a lower base plate 81 and a lower floor plate 110. The lower outer circular cap 36 may be attached to the outer base housing 20 in a variety of different ways. Various fasteners may be provided to secure the lower outer circular cap 36 thereto.

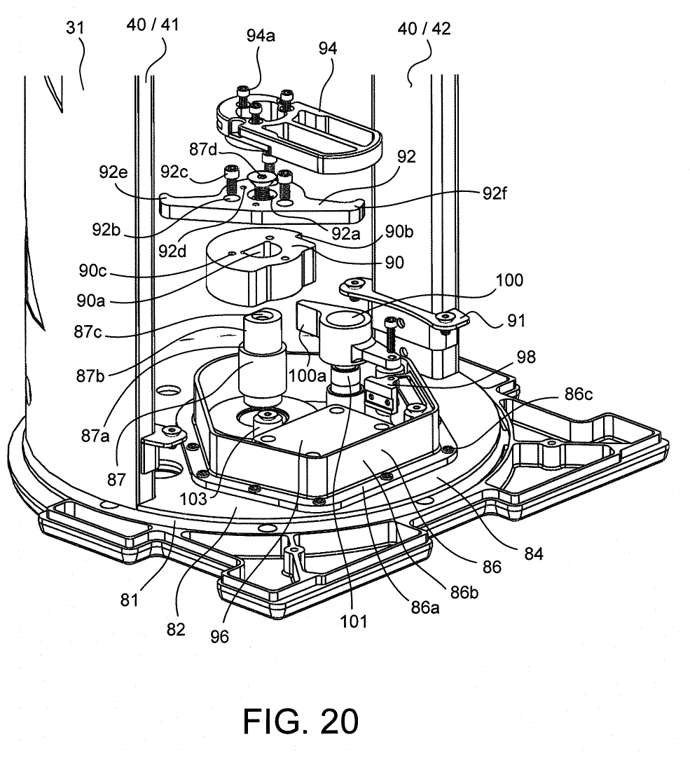

FIG. 20 shows an exploded perspective view of the lower locking mechanism 80 positioned in a locked position within the vertical frame members 40. The lower assembly 18 is composed of the lower base plate 81 being fixed to the rectangular outer base housing 20. The lower base plate 81 has an outer contour that includes the shape of the rectangular outer base housing 20 and the circular bearing plate 82.

Positioned within the lower assembly 18, the lower locking mechanism is 80 is inaccessible in the middle of the lower end of the weapon storage system 10. This position for the lower locking mechanism 80 is very difficult to obtain access to by a person trying to compromise its security and to gain access to the weapon storage system 10.

However, it is to be understood according to the subject matter of this disclosure, that the locking mechanism can be located in various locations within the construction of the weapon storage system 10. For example, the locking mechanism can also be suitably located in the top assembly 16, in the rectangular outer base housing 20 and/or any other suitable location within the weapon storage system 10.

The bearing plate 82 is fixed to the lower base plate 81. The lower main shaft 87 is disposed in the center of, and attached to the bearing plate 82 and the lower base plate 81. As shown in FIG. 19, a lower bushing 85 is disposed above the bearing plate 82 and concentric to the lower main shaft 87. The lower bushing 85 is connected to the lower door plate 84. The lower bushing 85 is disposed between the bearing plate 82 and the lower door plate 84 and allows the lower door plate 84 to rotate about the lower main shaft 87 without the bearing plate 82 being rotated.

A drill guard 86 is attached to the lower door plate 84 to protect the inner components of the lower locking mechanism 80 from being tampered with by an object such as a screw driver or other piercing tool, such as a drill, or the like. The drill guard 86 has an L-shape protective cross sectional view configuration. The lower leg of the L-shape cross section configuration is an outer flange 86a that surrounds the upward flange 86b portion of the L-shape. The outer flange 86a includes various fastener openings 86c adapted to receive various fasteners for attachment to the lower door plate 84.

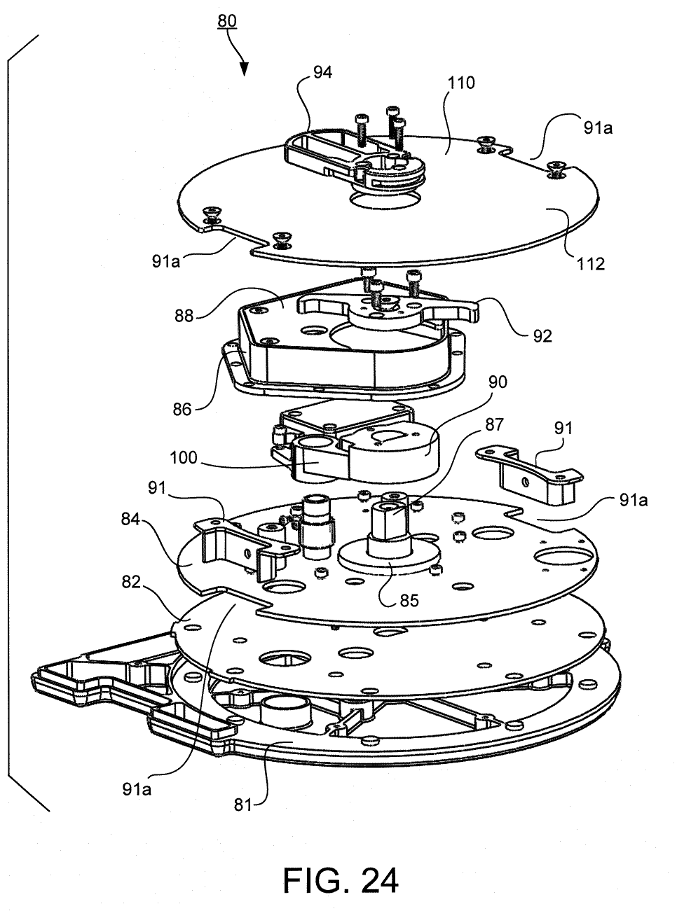

A bridge plate 88 (as shown in FIG. 24) is attached to an upper edge of the upward flange 86b portion of the L-shape of the drill guard 86. As shown in FIG. 24, the bridge plate 88 is a cover element that secures tampering of the locking mechanism 80 within the interior space within the drill guard 86 that securely houses the locking mechanism 80.

As shown in FIG. 20, the lower main shaft 87 has a shoulder 87a disposed at approximately its central position, and a flat portion 87b that is keyed at its upper end above the shoulder 87a.

A sear hub 90 is disposed concentrically over the lower main shaft 87 above the lower bushing 85. The sear hub 90 includes a central opening 90a having a shape that mates with the keyed flat portion 87b of the lower main shaft 87. The mating keyed connection between the lower main shaft 87 and the central opening 90a in the sear hub 90 permits the sear hub 90 to be rotationally fixed to the lower main shaft 87. The sear hub 90 is substantially curved and has a notched indentation 90b along its perimeter that is adapted to receive a sear lock 100 as will be described later.

A lower stop plate 92 is disposed above the sear hub 90, and is attached through an aperture 92a by a shaft fastener 87d to another aperture 87c in an upper end of the lower main shaft 87. The lower stop plate 92 further includes various apertures 92b adapted to receive various other fasteners 92c to apertures 90c in the sear hub 90.

The lower stop plate 92 has a central substantially circular base with a pair of arms 92e, 92f that extend from the central substantially circular base. The pair of arms 92e, 92f intermittently engage a lower sear stop shaft 101 at a first closed position and a second open position respectively.

The lower stop plate 92 is fixed to the lower main shaft 87 and does not rotate as the rotatable housing 30 rotates between a first closed position and a second open position. That is, when the rotatable housing 30 rotates a predetermined rotational distance between an unlocked or first open position and a locked or second closed position, the pair of arms 92e, 92f are engaged with the lower sear stop shaft 101 respectively.

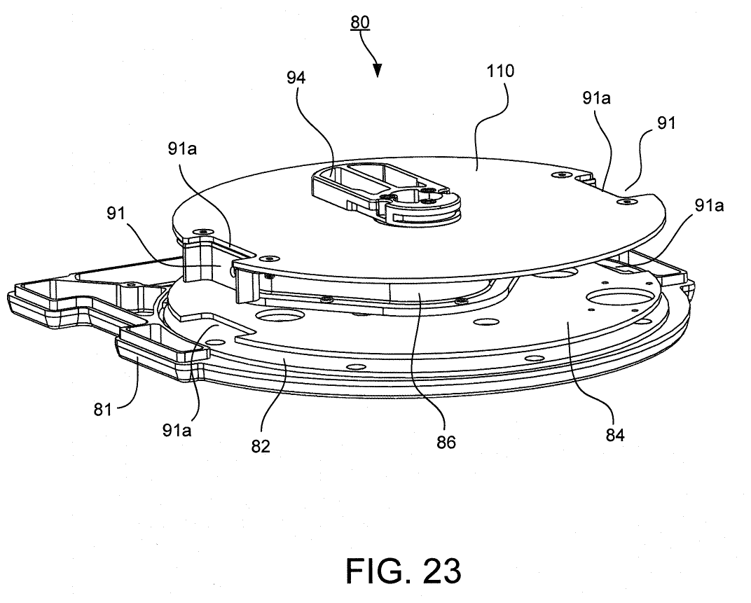

A pair of frame member guides 91 are adapted to secure the vertical frame members 40 in position between the lower door plate 84 and the lower floor plate 110. As shown, the frame member guides 91 have a u-shape configuration. The u-shaped frame member guides 91 can be inserted into mating recesses 91a (as shown in FIG. 23) disposed in the lower door plate 84 to the lower floor plate 110 and are adapted to secure the lower door plate 84 to the lower floor plate 110 in assembly.

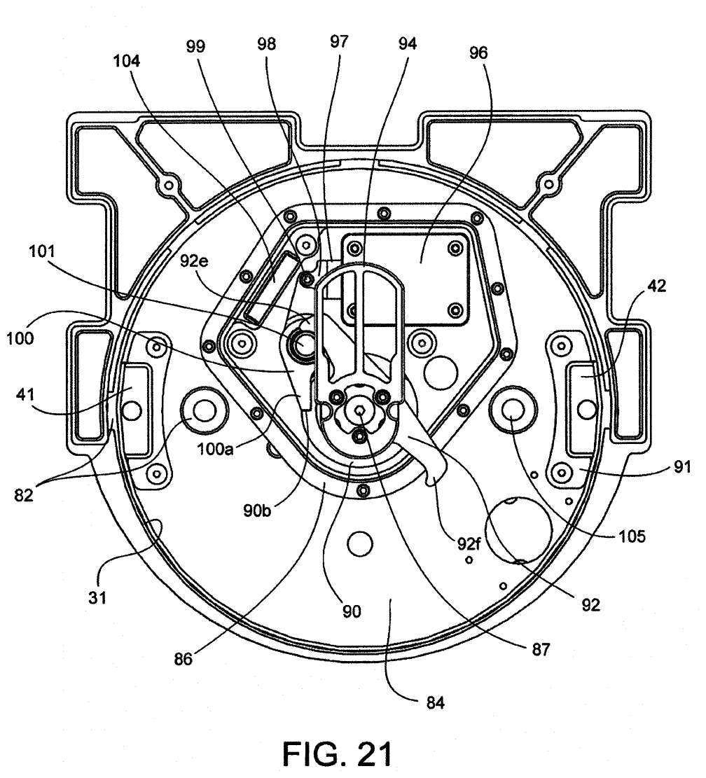

FIG. 21 shows a plate 104 disposed in front of the lock nose 97, lock clevis 98, clevis pivot 99 and sear lock 100. The plate 104 is a high strength protective plate which may be made of a variety of different materials, such as a hardened steel plate. The plate 104 is provided to block and protect the various vulnerable parts of the lower lock mechanism 80 form access, such as from a piercing tool, such as a drill trying to obtain access to the lower locking mechanism.

FIG. 21 also shows the lower locking mechanism 80 in a locked or closed position. As shown, the rotatable door 31 is facing forward away from the outer base housing 20, blocking access to the interior compartment 34 of the rotatable housing 30. The rotatable door 31 is secured between, and to the first vertical frame member 41 and the second vertical frame member 42. The rotatable housing 30 has been rotated so that the arm 92e engages the lower sear stop shaft 101. To move the rotatable housing 30 into an open position where the rotatable door 31 is rotated open, the lock body 96 must be actuated by the keypad 75 to retract the lock nose 97 and lock clevis 98 in toward the lock body 96 pivoting the projection 100a end out of the notched indentation 90a in the sear hub 90.

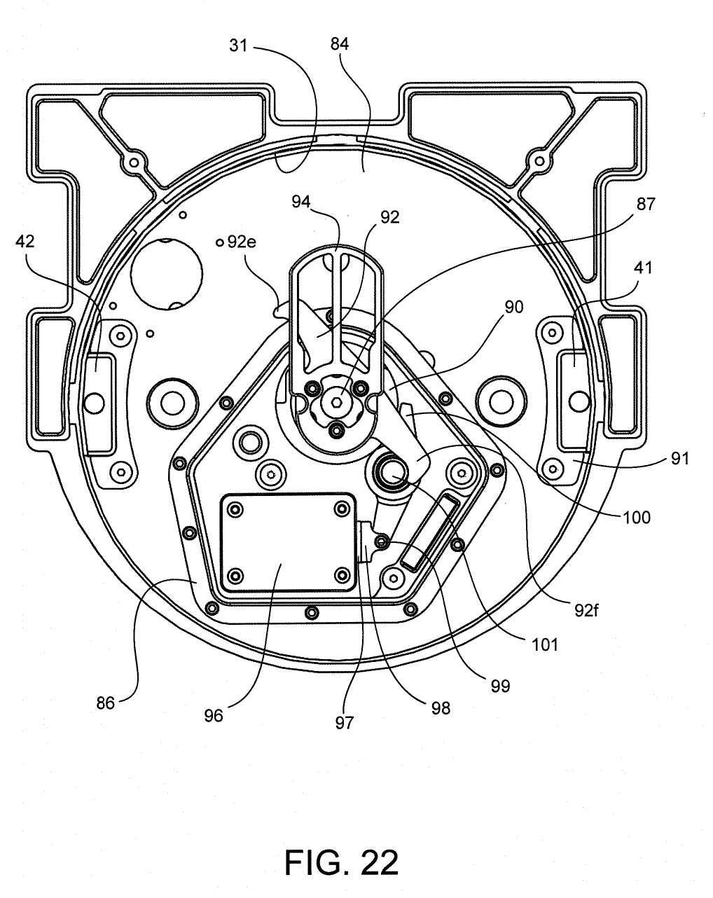

FIG. 22 shows the lower locking mechanism 80 rotated 180 degrees into an unlocked and open position. As shown, the rotatable door 31 has been rotated 180 degrees and is facing rearward and is positioned against and juxtaposed to the outer base housing 20, unblocking access to the interior compartment 34 of the rotatable housing 30. The first vertical frame member 41 and the second vertical frame member 42 has been rotated 180 degrees and exchanged positions. In this position, the door 31 has been removed from the opening into the interior compartment 34 and access to the interior compartment is provided by a large 180 degree opening defined by the open space disposed between the first vertical frame member 41 and the second vertical frame member 42. In this orientation, the open configuration of the rotatable housing 30 causes the internal compartment 34 and access thereto to thrust out forward from the outer base housing 20 for access into the internal compartment 34. That is, the rotatable housing 30 has been rotated in an opposite direction so that the arm 92f engages the lower sear stop shaft 101 at approximately 180 degrees from the closed position shown in FIG. 21.

The lower stop shaft 101 defines the boundaries between which the rotatable housing 30 may rotate. One example may be a 180 degree turn between a first and a second position to define an open and a closed position. In the second open position, the upper stop plate 66 butts up against the upper stop shaft 68, and in the same second open position, the lower stop plate 92 butts up against the lower stop shaft 101 correspond at equal rotational angles. Likewise, in the locked position, the upper stop plate 66 butts up against the upper stop shaft 68 at 180 degrees from the first open position, and in the same unlocked position, the lower stop plate 92 butts up against the lower stop shaft 101 at 180 degrees from the first open position, also correspond at equal rotational angles to close the weapon storage system 10.

As shown in FIGS. 19, 23 and exploded FIG. 24, a lower floor plate 110 is disposed above the lower stop plate 92. The lower floor plate 110 covers the interior compartment 18a defined within the lower assembly 18. The lower floor plate 110 may be a single piece construction or a multi-piece construction.

A lower locking mount 94 is then attached above, and to, the lower floor plate 110 and the lower stop plate 92 by the various fasteners 94a into various apertures provided in the lower stop plate 92. The lower locking mount 94 engages with the lower weapons cassette mount 47 in a quick disconnect manner and will be described in more detail later.

FIGS. 21-22 illustrate a locking element provided in the lower assembly 18. The locking element is comprised of a lock body 96 having a retractable lock nose 97 with a lock clevis 98 disposed on an end. The lock nose 97 of the lock body 96 is adapted to extend and retract into and out of the lock body 96. The extending and retracting motion may be in response to a mechanical or electronic switching element that actuates the movement of the lock nose 97 inward and outward of the lock body 96. The lock clevis 98 is attached at a pivot 99 to a sear lock 100. The sear lock 100 has a circular central body that is disposed concentric about the lower sear stop shaft 101.

As an electronic switching element, the lock body 96 is an electronic component or device that can switch an electrical circuit, i.e., by interrupting the current or diverting it from one conductor to another in response to actuation by another electronic element. The electronic switching element responds to an external force to mechanically or electrically change an electric signal. Switches are used to turn electric circuits ON and OFF and to switch electric circuits. One such example of the electronic switching element can be for example an electronic keypad 75.

FIGS. 10-11, 15 and 32 show a digital door lock embodied as a keypad 75 integrated into the handle cap 61. The keypad 75 may be embodied as a display interface and/or set of buttons arranged in a block or “pad” which usually bear digits, symbols and usually a complete set of alphabetical letters or numerals. The keypad may require a special code, such as a specific alphabetic, numeric, a specific pattern swipe and/or some input combination thereof to generate and send a signal from the keypad 75 to the lock body 96 to actuate movement of the lock nose 97 into or out of the lock body 96.

At rest, the lock nose 97 disposed within the lock body 96 may be biased in the locked position in which the projection 100a of the sear lock 100 is biased into the notched indentation 90a of the sear hub 90a shown in FIG. 21. The lock nose 97 may be spring loaded to bias the projection 100a into the notched indentation 90b of the sear hub 90. When the lock body 96 is actuated to an unlocked position by a correct code being received at the keypad 75, the projection 100a of the sear lock 100 is actuated to move away from the notched indentation 90b of the sear hub 90.

A wiring conductor 77 extends from an output in the keypad 75 to the lock body 96. As shown in FIG. 32, the wiring conductor 77 extends from the keypad 75 in the top assembly 16 to the lock body 96 disposed in the lower assembly 18. The wiring conductor is of sufficient length and gage and has a suitable conductor to transmit signals from the keypad 75 to the lock body 96 in the lower locking mechanism 80 to activate and deactivate the locking mechanism 80 disposed in the lower assembly 18.

FIGS. 21-22 illustrate the operation of the lower locking mechanism 80. When the lock body 96 is electronically actuated to lock the lower assembly 18 to prevent the rotatable housing 30 from being rotated, the projection or end or lock nose 97 extends out of the lock body 96 causing a projection or nose 100a extending from the circular central body of the sear lock 100 to pivot and move into the locking notched indentation 90b of the sear hub 90 thereby preventing the sear hub 90 from being rotated. The sear hub 90 will remain rotationally locked in the closed locked position until the lock body 96 is electronically released so that the nose 100a extending from the sear lock 100 is retracted and moved away from the locking notched indentation 90b. When the sear hub 90 is locked, the entire rotatable housing 30 is prevented from being rotated and suspended in a closed locked position as shown in FIG. 21.

When the sear hub 90 is unlocked by the sear lock 100, the rotatable housing 30 is allowed to rotate into an open unlocked position such as shown in FIG. 22. As shown, the sear lock 100 is unlocked from the sear hub 90 when the lock nose 97 is actuated to retract back into the lock body 96 and the nose 100a of the sear lock 100 is retracted from within the notched indentation 90b in the sear hub 90. When the sear hub 90 is unlocked, the entire rotatable housing 30 is allowed to rotate as depicted in FIG. 24. As shown in FIG. 24, the first and vertical frame member 41 and the second vertical frame member 42 are rotated 180 degrees from their initial position shown in FIG. 21.

The lock body 96 may be actuated by a variety of different actuating mechanisms, such as by a mechanical switch, an electronic switching mechanism and/or any other suitable actuation method. An electronic keypad can be positioned on the handle assembly 60 and an electrical conductor can be extended from the keypad to the lock body 96 in order to activate and deactivate the locking and unlocking of the lock body 96.

Referring back to FIG. 23, the lower locking mechanism 80 includes a lower locking mount 94 provided just above the lower floor plate 110. The lower locking mount 94 is adapted to be connected to the lower weapons cassette mount 47.

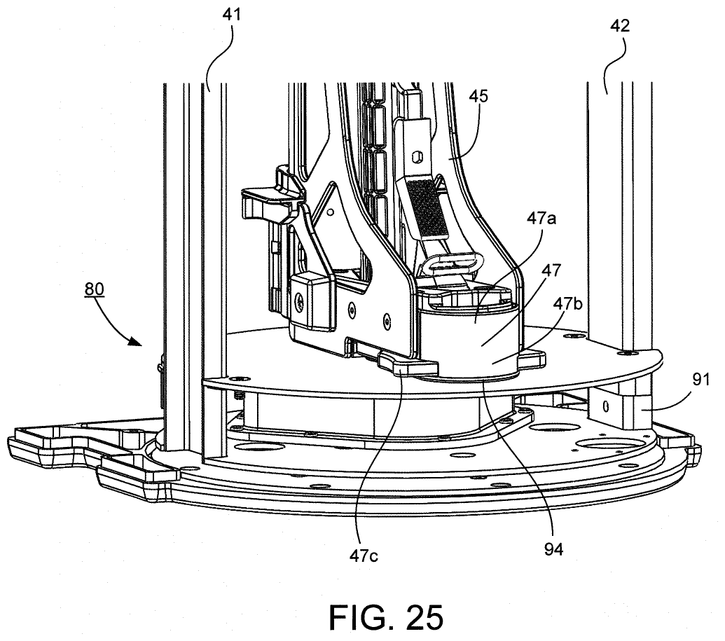

FIG. 25 shows a side view of the lower locking mount 94 connected to the lower weapons cassette mount 47 that is attached to the weapons cassette 45. The rotating door 31 is shown cut away to illustrate the interior compartment 34 of the rotatable housing 30. In use, the weapons cassette 45 is fixed and does not rotate as the rotatable housing 30 rotates between the unlocked position as shown in FIG. 22 and the locked position shown in FIG. 21.

The lower weapons cassette mount 47 is positioned at the lower end of the weapons cassette 45 and is adapted to engage and lock onto the lower locking mount 94 attached to the lower assembly 18 of the rotatable housing 30. The lower weapons cassette mount 47 of the weapons cassette 45 may be provided with various engagement configurations to lock onto the lower locking mount 94. For example, the lower weapons cassette mount 47 may have a receiving cup portion 47a with an outer guide 47b portion adapted to receive and align the lower locking mount 94 within the outer guides 47b. A pair of release levers 47c may be integrated into the lower weapons cassette mount 47 and function as latch release levers to release the lower locking mount 47 of the weapons cassette 45 in a quick manner when the release levers 47c are depressed.

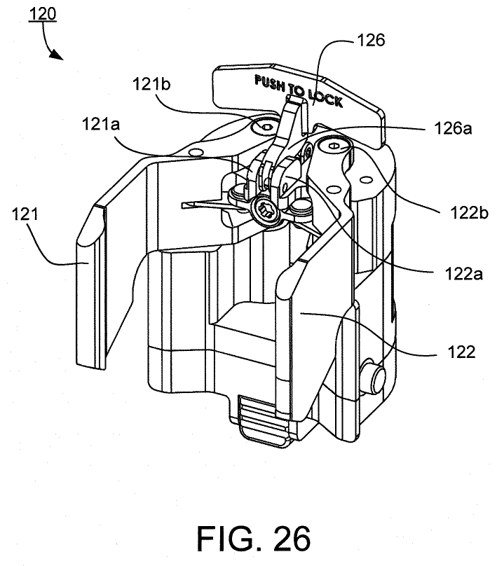

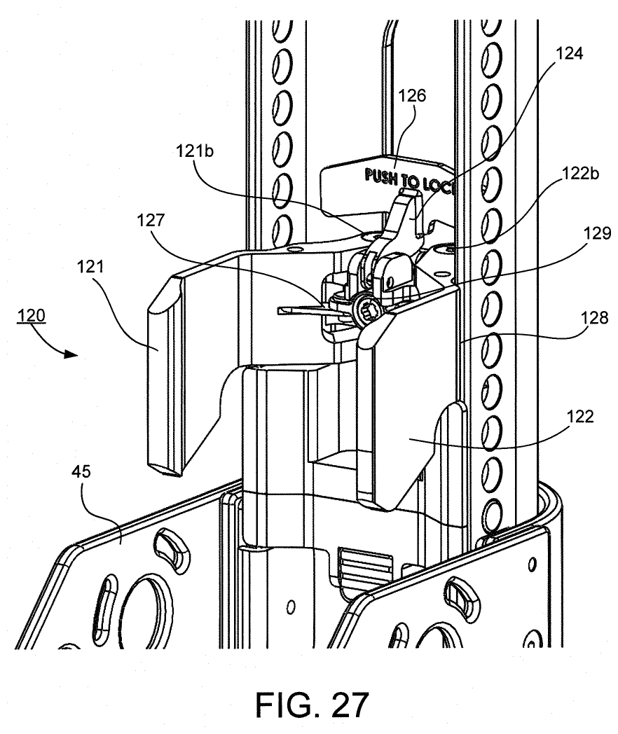

FIG. 26 depicts the weapon clamp 120, and FIG. 27 illustrates the weapons clamp secured to the weapons cassette 45. The weapon clamp 120 can be constructed in variety of different ways. This embodiment includes the clamp 120 having a first jaw 121 and a second jaw 122 adapted to move open and close. The clamp 120 may include an interior resilient grip portion composed of a flexible material that can be slightly compressed as the clamping force is applied during the closure process of the clamp 120. The first jaw 121 may pivot outward at a first pivot connection 121b and the second jaw 122 may pivot outward at a second pivot connection 122b.

The clamp 120 may be opened and closed by a lever 126 having a cam surface 126a that engages with mating cam surfaces 121a, 122a attached to the jaws 121, 122 to open and close the jaws 121, 122 based on the position of the lever 126 and its cammed surface 126a biasing against the cammed surfaces 121a of the first jaw 121 and the cammed surface 122a of the second jaw 122.

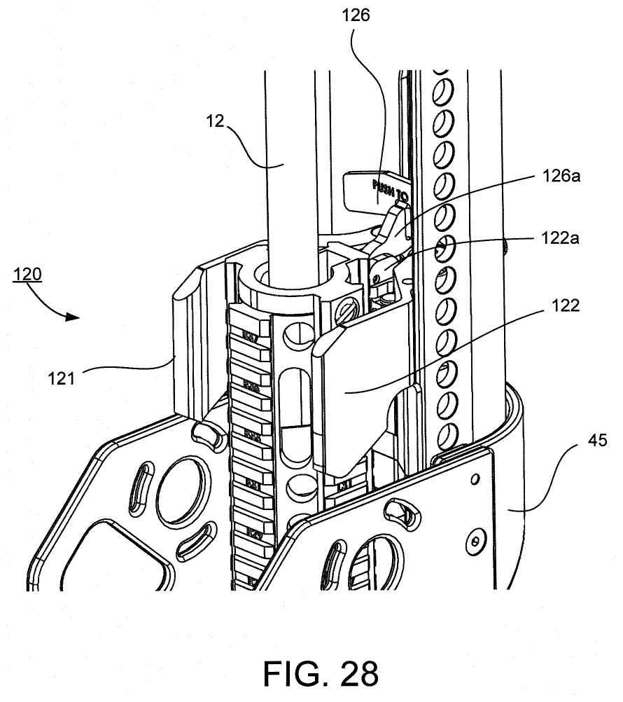

In FIGS. 27-28, the weapon clamp 120 is shown disposed on the weapon cassette 45 and is positioned adjacent to a barrel of a weapon 12. In use, the jaws 121, 122 are secured by the clamp 120 onto the barrel of the weapon 12 in such a way, and with a force, that the weapon cannot be removed without opening the clamp 120. Although shown attached to the barrel of a weapon, it is to be understood that the weapons clamp 120 can be constructed to clamp onto any portion of a weapon according to this subject disclosure.

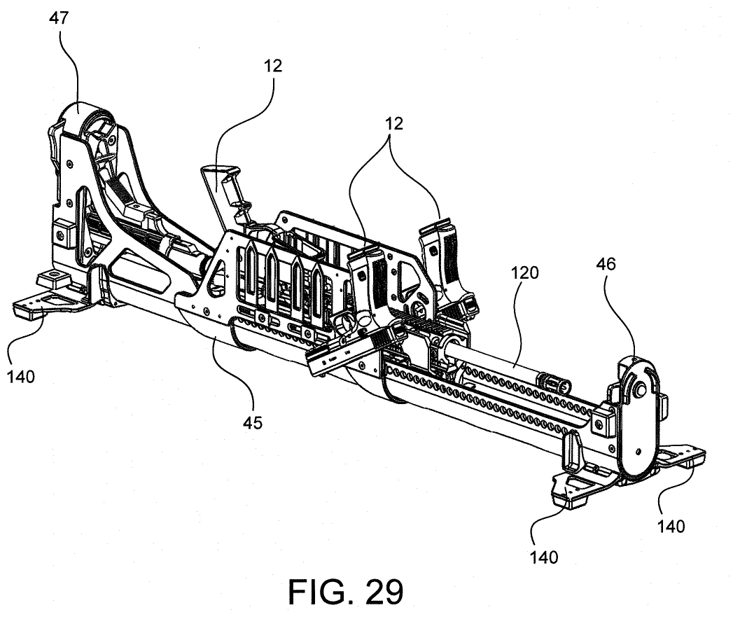

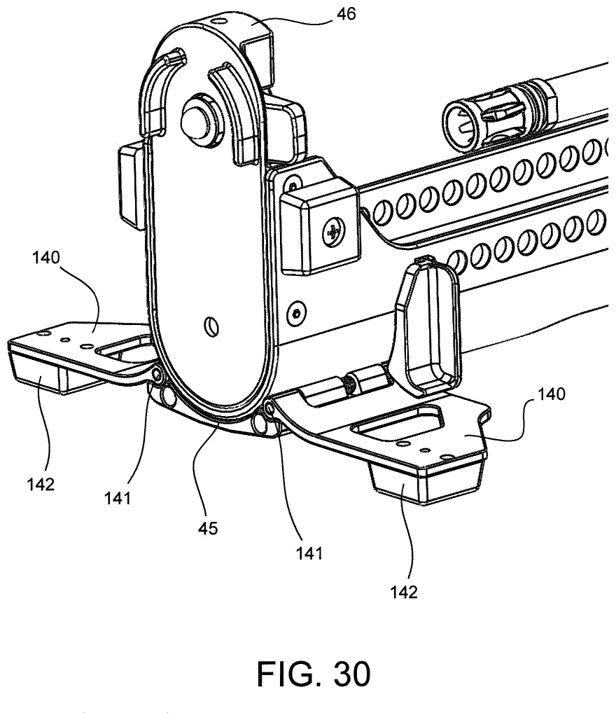

FIGS. 29-30 shows retractable feet 140 adapted for use with the weapons cassette 45. The retractable feet 140 are provided to enable the weapons cassette to sit upright in a stable secure manner when the weapon cassette is laid onto a surface. The retractable feet 140 pivot inward adjacent to the cassette when in a storage position and outward into an open position as shown in FIG. 29 to widen the footprint of the weapons cassette. Resilient pads 142 may be provided at the ends of the feet 140 for enhanced support and stability.

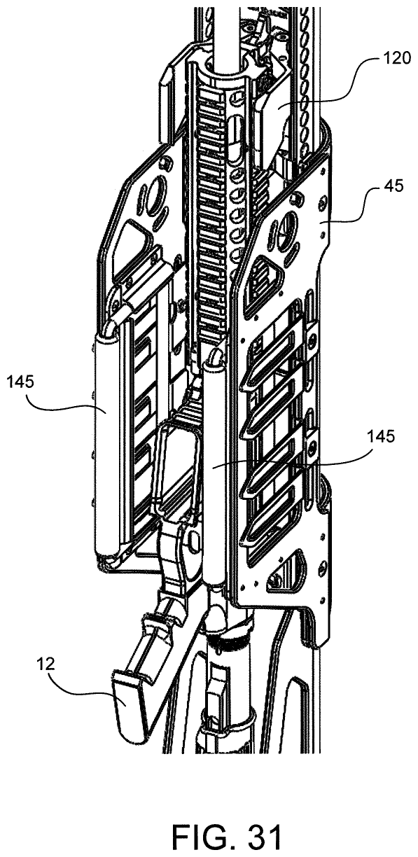

FIG. 31 shows an enlarged view of the weapons cassette 45 including a pair of retractable handles 145. The retractable handles 145 make it easier to transport the weapons cassette 45 during transport. A user can gain a better grip on the weapons cassette 45 by using the retractable handles 145.

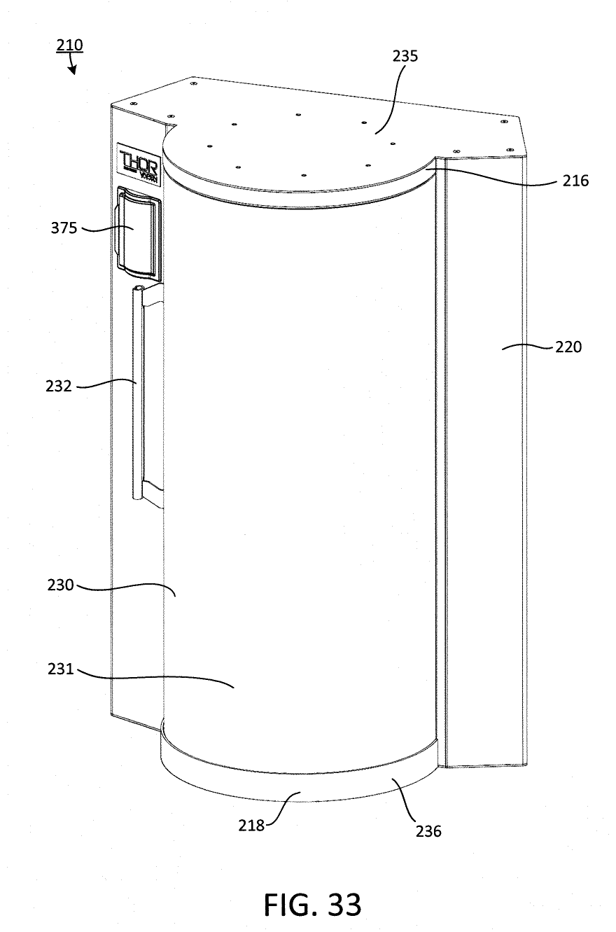

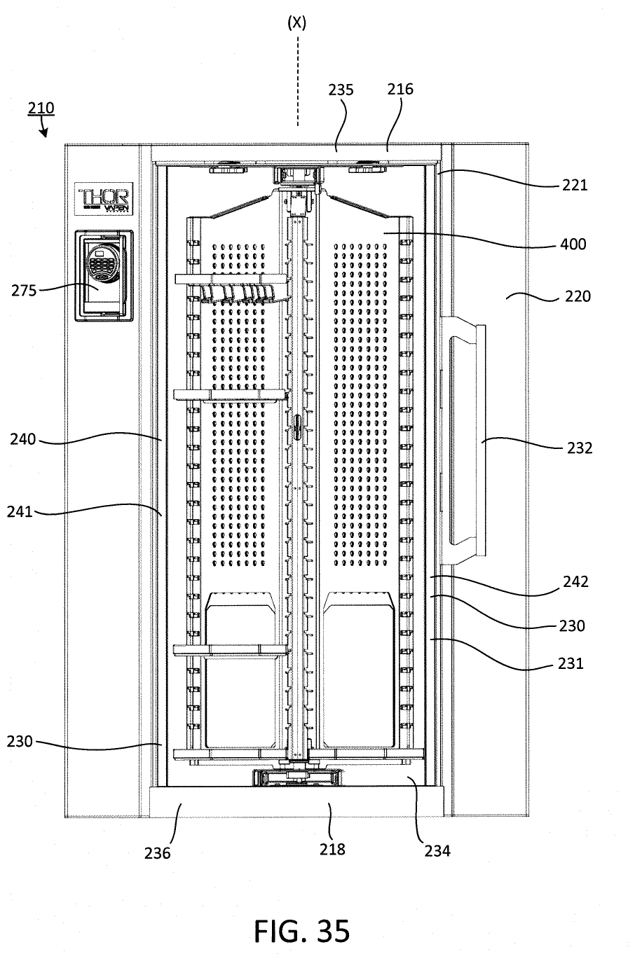

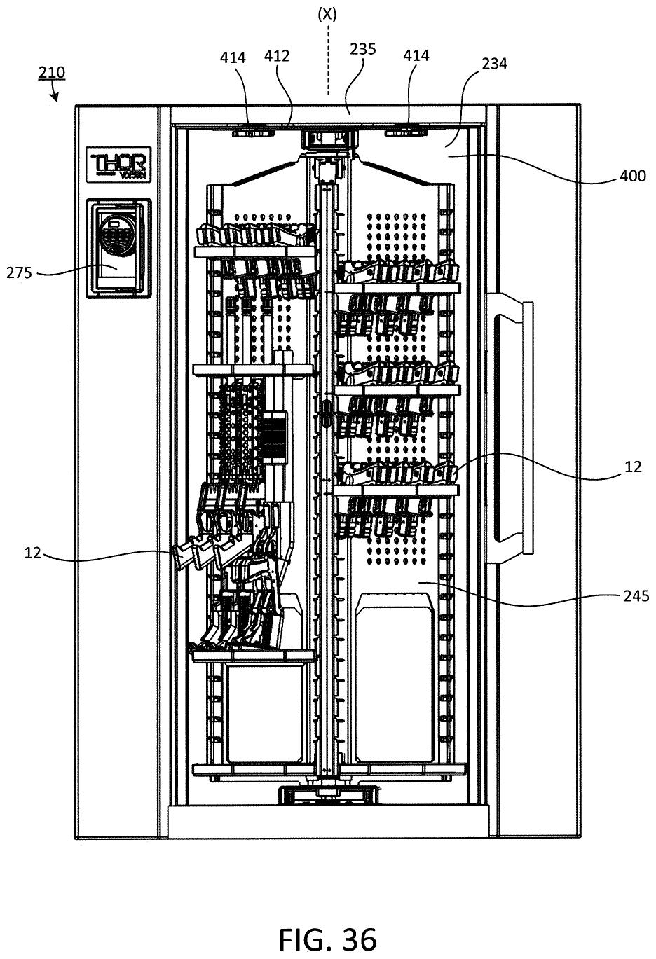

FIGS. 33-36 illustrates a second embodiment for a valuable item or storage system 210 according to this subject disclosure. Various advantages will be described below by the construction of the storage system 210. The construction of the storage system 210 provides for a large 180 degree access opening to an internal compartment 234 in an unlocked open position sown in FIGS. 35-36. A locking mechanism 280 may be positioned in a remote, hard to access, location within a lower assembly 218 of the storage system 210. A code input receiver, such as a keypad 275 may be positioned atypically distant from the locking mechanism 280 further ensuring the inability to break into the storage system 210. Another advantage of the storage system 210 is the ability to slide a rack assembly 400 disposed within the internal compartment 234 outward from the internal compartment 234 along a track to rapidly gain access to weapons 12 stored thereon.

The second embodiment of the storage system 210 shown in FIGS. 33-36 is substantially similar to that shown and described for the first embodiment of the storage system 10, shown and described in FIGS. 1-6 and 10-24. The description provided above with respect to the first embodiment applies in part to the second embodiment and will not be repeated for sake of brevity.

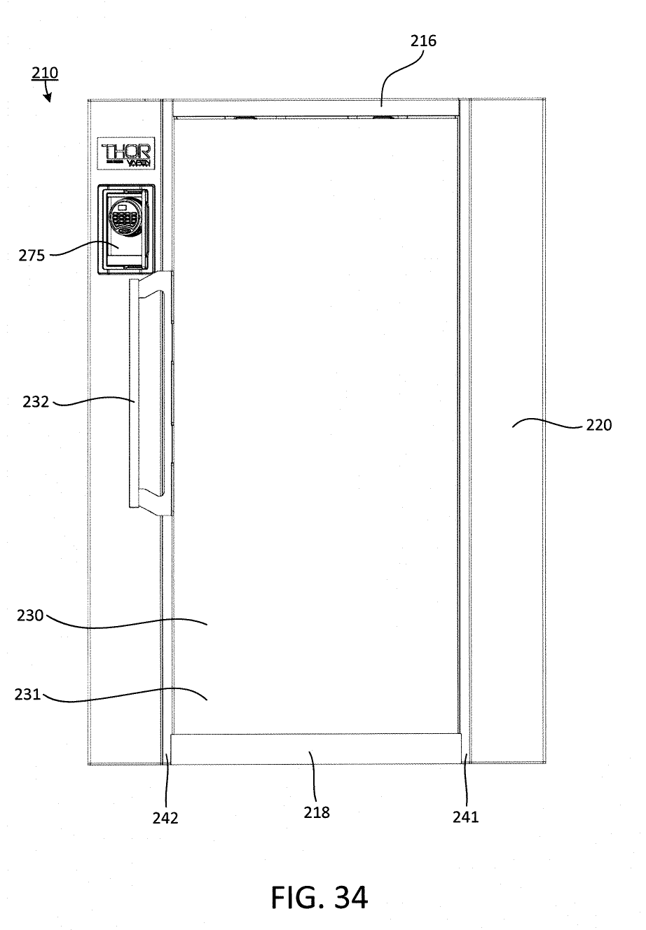

As shown in FIGS. 33-34, the storage system 210 has an elongated upright tall profile. The storage system 210 may have a rectangular outer base housing 220 bounded by a lower assembly 218 and a top assembly 216. The outer base housing 220 has an elongated curved inner structure 221. The rectangular outer base housing 220, the lower assembly 218 and the top assembly 216 partially encase an integrated cylindrical or arcuate shaped housing door. The arcuate housing door is an elongated upright inner secure rotatable housing 230 as shown in FIGS. 35 and 37-38.

The rotatable housing 230 has an arcuate shape and is rotated about a center axis (X) between an open position (shown in FIG. 35) and a closed position (shown in FIG. 34) by a handle 232 provided on the rotatable housing 230 to enable access to a weapons rack assembly 245 securing various weapons 12 stored in an interior compartment 234 as shown in FIG. 36. As will be discussed in more detail later, a key pad 275 is electronically connected to a locking mechanism 280 (shown in FIGS. 39 and 40) located in the lower assembly 218 and is adapted to lock and unlock the rotation of the rotatable housing 230.

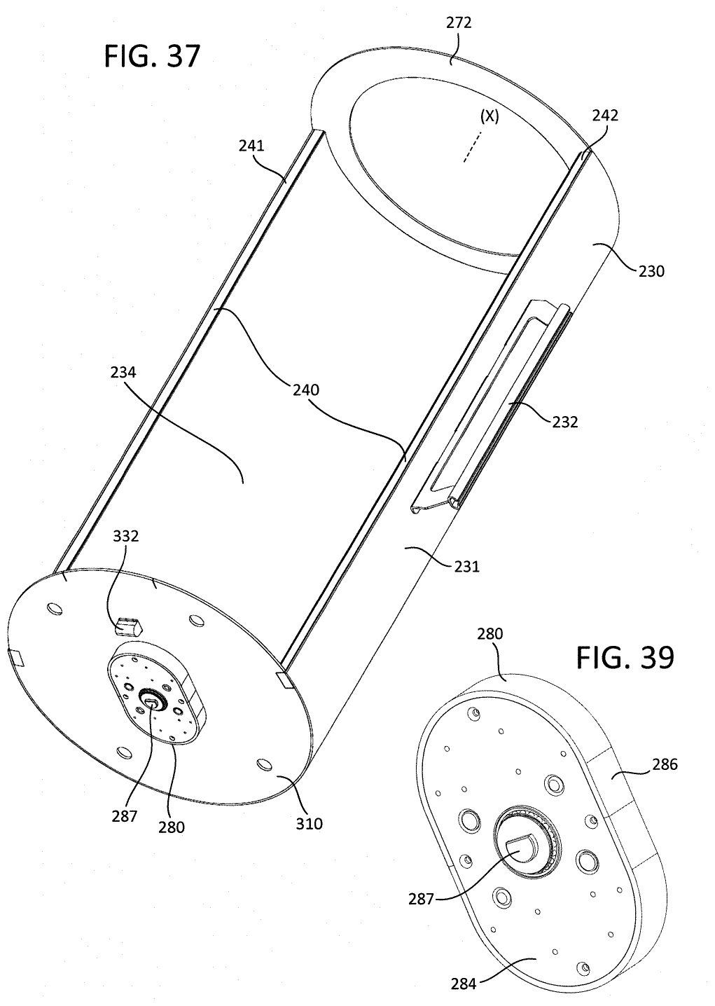

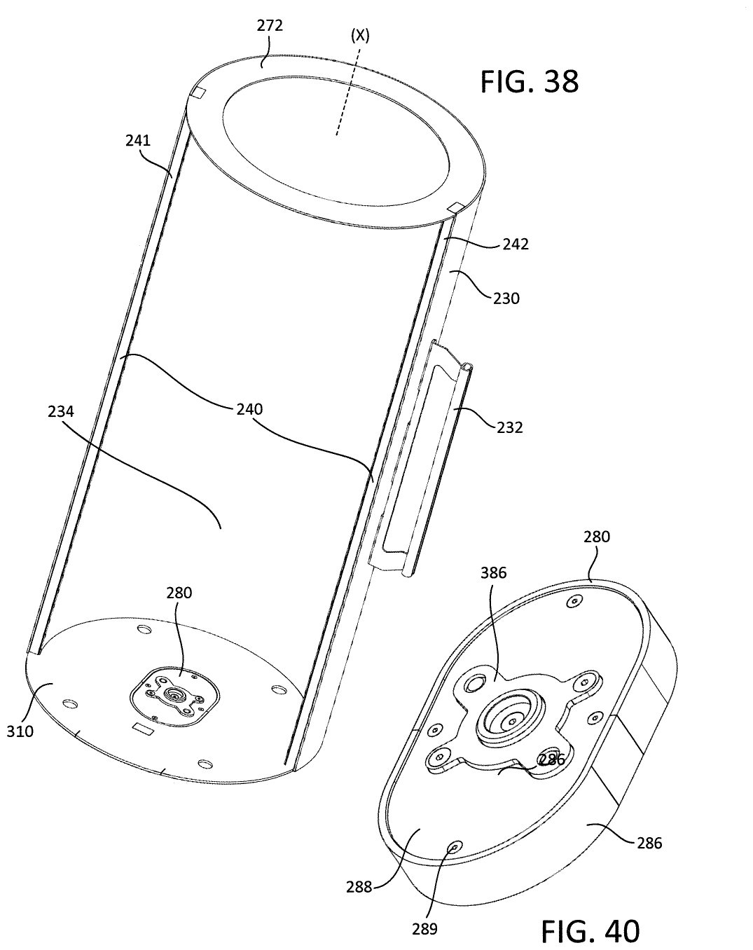

FIGS. 37 and 38 show the rotatable housing 230 is constructed in a tubular vertical shape and includes a pair of vertical frame members 240 having a first vertical frame member 241, and a second vertical frame member 242 opposite the first vertical frame member 241. The first vertical frame member 241 and second vertical frame member 242 are attached between the upper door plate 272 and the lower door plate 310, all of which rotate together as an integrated unit being a part of the rotatable housing 230.

In the closed position (shown in FIG. 34), the weapons rack 245 securing the weapons 12 is fixed in rotation and the rotatable housing 230 rotates around the weapons rack 245 from the closed position to the open position (shown in FIG. 35). As will be described in more detail later, when the rotatable housing 230 is in an open position, the weapons rack 245 is capable of sliding outward along tracks 410, 420, away from within the internal compartment 234 within the base housing 220, so that the weapons 12 may be more easily accessed. When the weapons rack 245 has been extended completely outward along the tracks 410, 420 from the base housing 220, a non-rotation element may be disengaged to allow the weapons rack 245 to rotate to allow access to all of the weapons 12 supported by the weapons rack 245 in a convenient manner.

In FIG. 35, the rotatable housing 230 has been rotated approximately 180 degrees from the locked or closed position shown in FIG. 34 to the open position shown in FIG. 35. The rotating door 231 of the rotatable housing 230 has been rotated and lies adjacent to an inner curved surface 221 or non-rotatable curved inner structure of the rectangular outer base housing 220. The non-rotatable inner curved surface 221 may take a variety of different shapes, such as for example a u-shaped curve, a cylindrical curve or some other curve with a predetermined radius of curvature. The non-rotatable inner curved surface 221 is provided to rotationally mate concentrically with the rotatable housing 230 adjacent to the non-rotatable inner curved surface 221.

As shown in FIGS. 35-38, the interior compartment 234 within the rotatable housing 230 is constructed as an elongated cylindrical housing. The door 231 is integrated with the rotatable housing 230 and is attached between the vertical frame members 240 and the upper door plate 272 and the lower door plate 310, and rotates between the closed position (FIG. 34) and an open position (FIG. 35).

FIG. 36 shows the weapons rack 245 securely mounted within the interior compartment 234 of the storage system 210. The weapons rack 245 may also be adapted to store and secure various weapons such as a rifle, a hand gun, a high voltage weapon, a baton, magazines, a knife, flashlight, tear gas, handcuffs, vest, pepper spray, ammunition and other weapons and equipment suitable for law enforcement use. Alternatively, a different type of storage rack (not shown) may be integrated into the interior compartment 234 of the storage system 210 to store various other valuable items, such as jewelry, coins, and/or any other item of significant value to s user.

As with the weapons storage system 10 described previously, various mounting channels (similar to that shown in FIG. 10) can be provided about the various outer surfaces of the outer base housing 220 for securing the storage system 210 to another surface, such as a wall. A mounting bracket such as a mating elongated rigid bar can be securely anchored to the wall or other surface by various threaded secure fasteners. Alternatively, the storage system 210 can be mounted to the surface upon which it is resting, such as a floor and/or any other suitable surface.

As shown in FIGS. 33-38, the handle 232 is secured to door 231 of the rotatable housing 230. The handle 232 allows a user to rotate the rotatable housing 230 approximately 180 degrees between the closed position and the open position.

FIG. 35 depicts a front view of the storage system 210 illustrating the top assembly 216 and the lower assembly 218 in the storage system 210. An upper circular cap 235 is provided at the top assembly 216 upper end to retain and secure the upper door plate 272 or upper end of the rotatable housing 230 as will be described in more detail below. A lower circular cap 236 is provided at the lower assembly 218 of the secure rotatable housing 230 to retain and secure the lower door plate 310 or lower end of the rotatable housing 230.

The upper circular cap 235 may be semicircular in shape (as shown in FIG. 33) and may be attached to the base housing 220. Alternatively, the upper circular cap 235 may be circular and may be recessed and securely attached within a semicircular channel (not shown) provided at the upper end of the base housing 220. The upper circular cap 235 covers and prevents access to the interior compartment 234 through the top assembly 216. It is to be understood that various other constructions for the upper circular cap 235 are possible according to this subject disclosure.

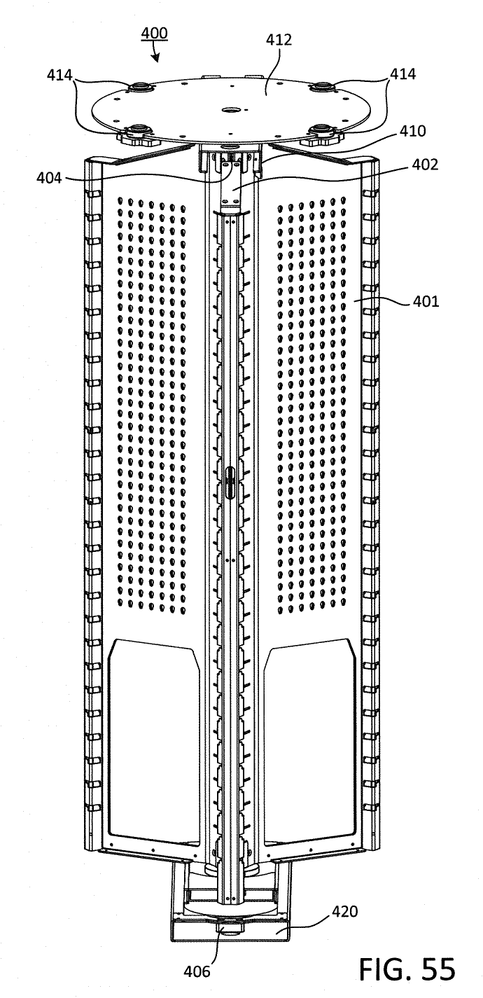

Referring to FIGS. 36 and 55, an upper rack plate 412 is fixed to the top assembly 216 under the upper circular cap 235. The upper rack plate 412 has a plurality of bearings 414 concentrically attached to its periphery. The upper door plate 272 of the rotatable housing 230 is captured by the upper rack plate 412 and rotates on the bearings 414 as it is rotated between the 180 degree open and closed positions. That is, the upper door plate 272 of the rotatable housing 230 is suspended by the upper rack plate 412 and permitted to rotate on the bearings 414. In this construction, the bulk of the weight on the weapons rack 245 is not carried by the rotatable housing 230, but instead is directly carried by an upper connection to the upper rack plate 412 from the weapons rack 245.

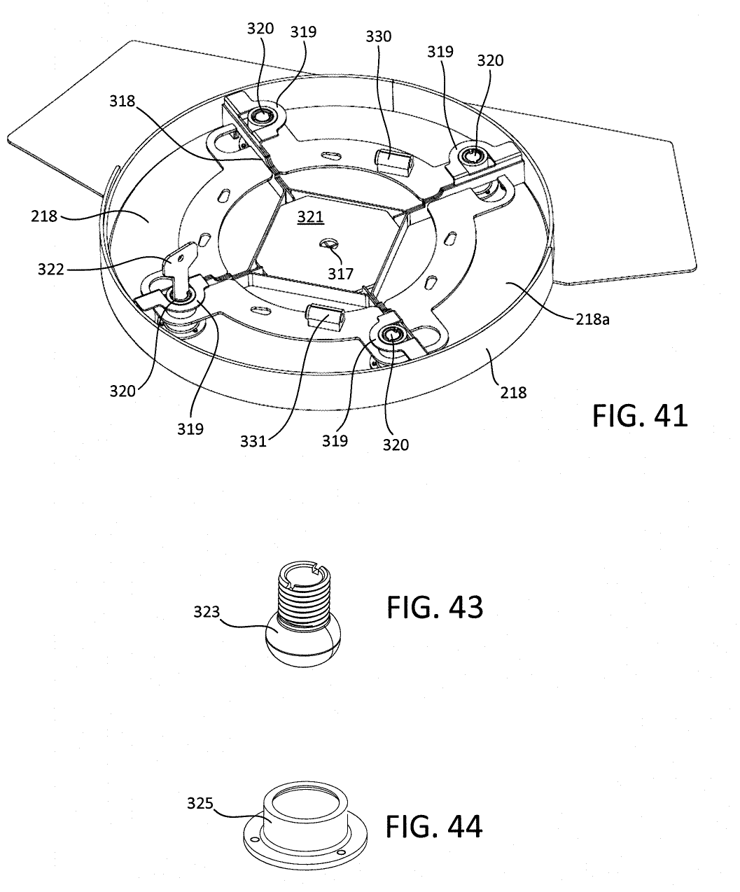

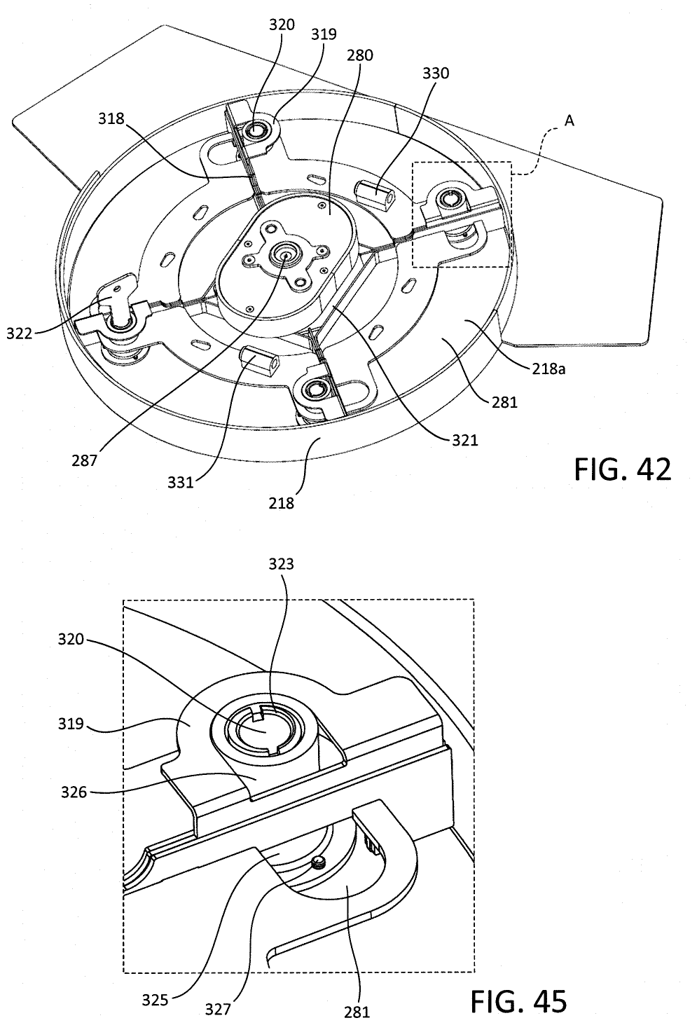

FIG. 41 shows an upper perspective view of the lower assembly 218 without the locking mechanism 280, and FIG. 42 shows an upper perspective view of the lower assembly 218 with the locking mechanism 280 mounted thereon. The lower assembly 218 includes a lower base plate 281 adjustably connected to an end cap lower brace 318. The lower base plate 281 is a floating plate. The end cap lower brace 318 has a center platform 321 onto which the locking mechanism 280 is attached. The lower brace 318 is disposed in an interior space 218a between the lower base plate 281 and the lower door plate 310 of the rotatable housing 230.

The lower brace 318 includes various adjustable levelers 320 adapted to adjust the floating lower base plate 281. FIG. 45 is an exploded view of section A illustrating the adjustable levelers 320 in more detail. The lower brace 318 includes a level retainer 319 portion having various adjustable levelers 320 disposed at various locations along the lower brace 318. As a result of the varying weight of the storage system 210 and the contents stored therein, it may be necessary to adjust the level of the storage system 210 from time to time. The level of the storage system 210 is made by adjusting the height of the floating lower base plate 281. The adjustable levelers 320 may be adjusted by an adjustment key 322.

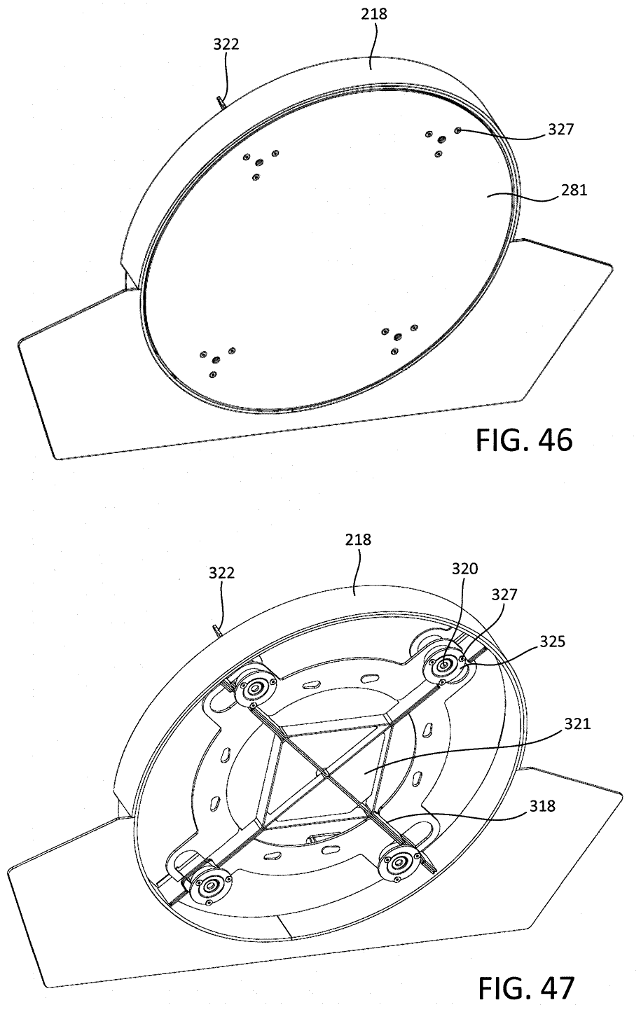

As shown in FIGS. 41-47, the adjustable levelers 320 may include a nut 326, a ball screw 323 and a ball screw cup 325. The nut 326 is fixed to the lower brace 318 which is fixed to the lower assembly 218. The ball screw 323 is threaded into the nut 326. The ball screw cups 325 are internally attached to the ball screw 323. A lower end of the ball screw cups 325 is attached to the lower base plate 281 by various fasteners 327 as shown in FIGS. 45 and 46. Turning the threaded ball screw 323 clockwise or counter-clockwise within the threads inside of the nut 326 will adjust a length of the height of the ball screw 323 higher or lower within the nut 323 thereby increasing or decreasing the height of the lower base plate 281 at that location in the lower assembly 218. Optimally adjusting the various adjustable levelers 320 at each of its locations will allow the storage system 210 to account for the varying distributed weight on the weapons rack 245 that rotates. Likewise, the height position of the storage system 210 can also be adjusted.

FIGS. 41-42 further illustrate a pair of stop lugs 330, 331 positioned on the lower brace 318. As shown, the first stop lug 330 and the second stop lug 331 are positioned at approximately 180 degrees from each other about the lower main shaft 287 in the locking mechanism 280. The stop lugs 330, 331 are positioned to set the 180 degree rotational boundary that the rotatable housing 230 is allowed to rotate. As shown in FIG. 37, a door stop 332 is provided on a lower surface of the lower door plate 310 that rotationally interacts with the stop lugs 330, 331.

When the rotatable housing 230 is in a closed position, the door stop 332 is adjacent to, and butt up against, the first stop lug 330. When the rotatable housing 230 has been rotated into an open position, the door stop 332 is adjacent to, and butt up against, the second stop lug 331. As the rotatable housing 230 is turned from the closed position to the open position, the door stop 332 rotates from the closed position being butt up against that first stop lug 330 to the open position being butt up against the second stop lug 331.

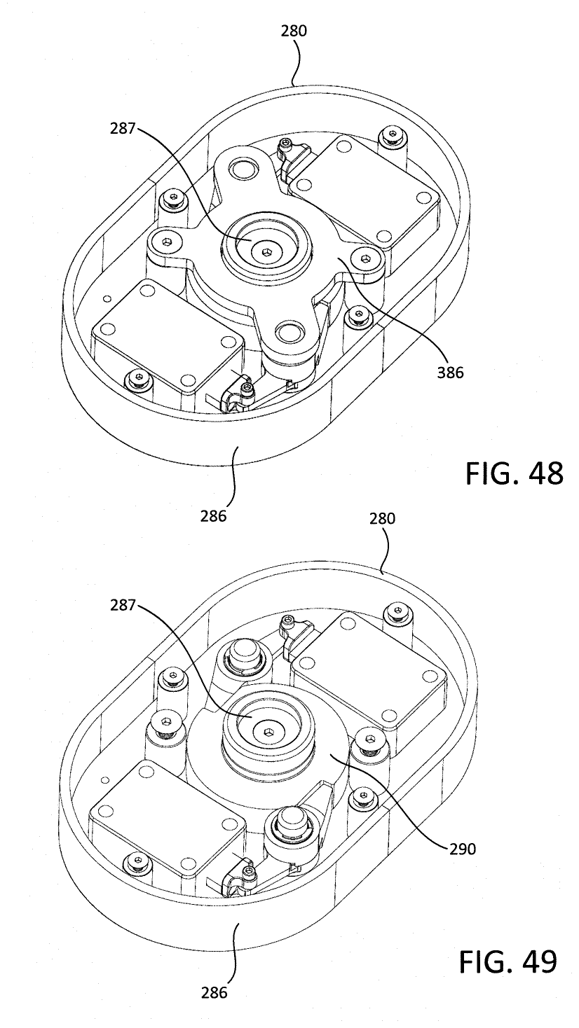

Referring back to FIG. 40, the locking mechanism 280 is securely contained within the drill guard 286 and under a bridge plate 288 and a sear plate 386. FIG. 48 shows the locking mechanism 280 with the bridge plate 288 removed, and FIG. 49 shows the locking mechanism 280 with the sear plate 386 also removed. In use, the lower main shaft 287 is fixed to the sear hub 290 which is also fixed and does not rotate.

As shown in FIGS. 37, 39 and 41, the lower end of the main shaft 287 has a keyed configuration. The lower end is keyed to fit into an aperture 317 in the center platform 321 (FIG. 41) on the lower brace 318. In position, the main shaft 287 is fixed to the lower brace 318 from rotation. Likewise, the sear hub 290 that is fixed to the main shaft 287 is also fixed when the rotatable housing 230 rotates between a closed and an open position.

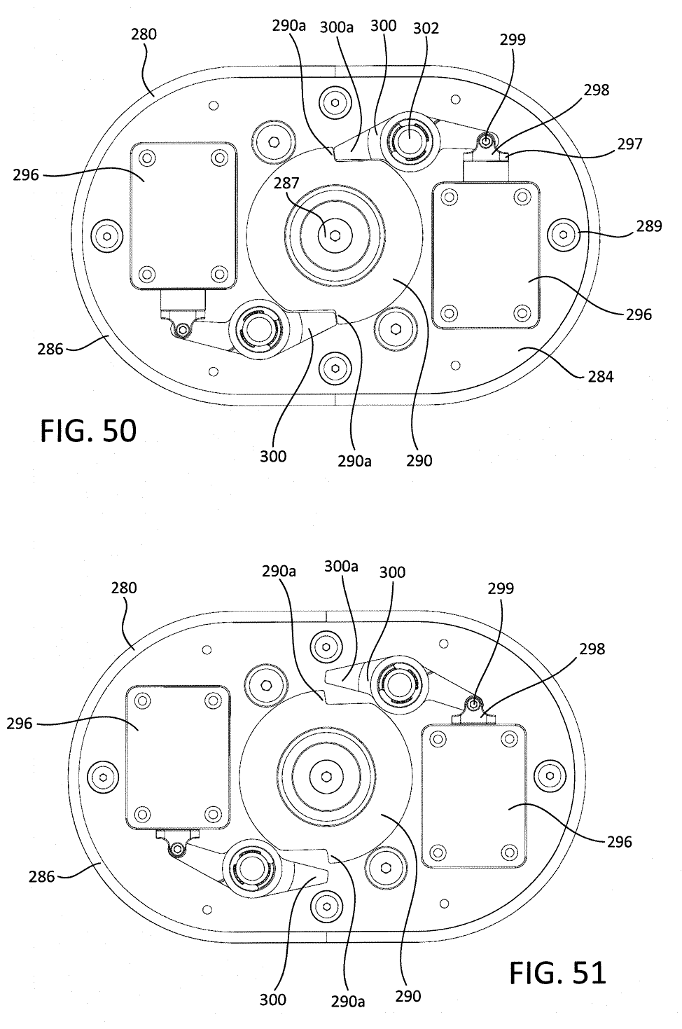

FIG. 50 shows the internals of the locking mechanism 280 without the bridge plate 288 and the sear plate 386 connected. In particular, the lower locking mechanism 280 is shown positioned in a locked position. As shown in FIG. 42, the locking mechanism 280 is positioned centrally within the lower assembly 218. The locking mechanism 280 is inaccessible in the middle of the lower end of the storage system 210. This position for the locking mechanism 280 is very difficult to obtain access to by a person trying to compromise its security and to gain access to the storage system 210.

However, it is also to be understood according to the subject matter of this disclosure, that the locking mechanism 280 can be located in various locations within the construction of the storage system 210. For example, the locking mechanism can also be suitably located in the top assembly 216, in the rectangular outer base housing 220 and/or any other suitable location within the storage system 210.

Referring to FIG. 50, a drill guard 286 is attached to the lower plate 284 (FIG. 39) to protect the inner components of the locking mechanism 280 from being tampered with by an object such as a screw driver or other piercing tool, such as a drill, or the like. The drill guard 286 may be attached in a variety of different ways, such as by being welded or using fasteners or the like.

The bridge plate 288 (FIG. 40) is attached to various bridge projections 289 adjacent to an upper edge of the drill guard 286. The bridge plate 288 is a cover element that secures from tampering of the interior space of the locking mechanism 280.

As shown in FIGS. 39 and 41, the lower main shaft 287 may have various shoulders or contours that are keyed into mating components. For example, the lower end of the main shaft 287 is keyed into and fixed to the aperture 317 in the center platform 321 of the lower brace 318. Similarly, an upper end of the main shaft 287 may be keyed (not shown) into and attached to a sear hub 290. In use, the main shaft 287 and the sear hub 290 are fixed. The remainder of the locking mechanism 280 rotates with the rotatable housing 280 since the locking mechanism 280 is attached to the rotatable housing 230.

As shown in FIG. 50, the sear hub 290 is disposed concentrically over the lower main shaft 287 above a lower bushing. The sear hub 290 includes a central opening that mates with the lower main shaft 287. The connection between the lower main shaft 287 and the sear hub 290 is rotationally fixed. The sear hub 290 is substantially curved and has notched indentations 290a along its perimeter that are adapted to receive sear locks 300 controlled to engage by a pair of lock bodies 296 as will be described later.

As shown in FIGS. 34 and 50, the locking mechanism 280 is in a locked or closed position. The rotatable door 231 is facing forward away from the outer base housing 220, blocking access to the interior compartment 234 within the rotatable housing 230. The rotatable door 231 is secured between, and to the first vertical frame member 241 and the second vertical frame member 242. The rotatable housing 230 has been rotated so that the door stop 332 engages the first stop lug 330a (FIGS. 37 and 41).

FIG. 51 shows the rotatable housing 230 into an open position where the rotatable door 231 is rotated open 180 degrees, the pair of lock bodies 296 must be actuated by the keypad 275 to retract the lock nose 297 and lock clevis 298 in toward the respective lock bodies 296 pivoting the projection 300a end out of the notched indentations 290a in the sear hubs 290.

FIG. 51 shows the lower locking mechanism 280 rotated 180 degrees into an unlocked and open position. As shown in FIG. 35, the rotatable door 231 has been rotated 180 degrees and is facing rearward and is positioned against the non-rotatable curved inner structure 221 and juxtaposed to the outer base housing 220, unblocking access to the interior compartment 234 of the rotatable housing 230. The first vertical frame member 241 and the second vertical frame member 242 have been rotated 180 degrees and exchanged positions.

In this position, the door 231 has been rotated and removed from the opening allowing access into the interior compartment 234. The access opening to the interior compartment 234 is provided by a large 180 degree opening defined by the open space disposed between the first vertical frame member 241 and the second vertical frame member 242. That is, the rotatable housing 230 has been rotated in an opposite direction so that the door stop 332 engages the second stop lug 330b (FIGS. 37 and 41) at approximately 180 degrees from the closed position as shown in FIG. 35.

Referring back to FIG. 50 in more detail, a pair of locking elements are provided in the lower assembly 218 according to the subject disclosure. Each of the locking elements are comprised of a lock body 296 having a retractable lock nose 297 with a lock clevis 298 disposed on an end. The lock nose 297 of the lock body 296 is adapted to extend and retract into and out of the lock body 296. The extending and retracting motion may be in response to a mechanical or electronic switching element that actuates the movement of the lock nose 297 inward and outward of the lock body 296. The lock clevis 298 is attached at a pivot 299 to a sear lock 300. The sear lock 300 has a circular central body that is disposed concentric about a lower sear shaft 302. The lock body 296 is similar in function to the lock body 96 in the storage system 10 and responds to the electronic keypad 275 in the base housing.

FIGS. 33-36 show a digital door lock having a protective door 375 and a keypad 275. Under the door 375, a keypad 275 may be integrated into the base housing 220. The keypad 275 may be embodied as a display interface and/or set of buttons arranged in a block or “pad” which usually bear digits, symbols and usually a complete set of alphabetical letters or numerals. The keypad 275 may require a special code, such as a specific alphabetic, numeric, a specific pattern swipe and/or some input combination thereof to generate and send a signal from the keypad 275 to the lock body 296 to actuate movement of the lock nose 297 into or out of the lock body 296. The signal from the keypad 275 to activate the lock body 296 may be a wired or wireless signal.

In FIG. 50, and at rest, the lock nose 297 disposed within the lock body 296 may be biased in the locked position (shown in FIG. 50) in which the projection 300a of the sear lock 300 is biased into the notched indentation 290a of the sear hub 290. In this position, the rotatable housing 230 is locked closed and cannot be opened. The lock nose 297 may be spring loaded to bias the projection 300a into the notched indentation 290a of the sear hub 290. When the lock body 296 is actuated to an unlocked position by a correct code being received at the keypad 275, the projection 300a of the sear lock 300 is actuated to move away from the notched indentation 290a of the sear hub 290 as shown in FIG. 51.

Similar to the diagram shown in FIG. 32, a wiring conductor 77 may extend from an output in the keypad 275 on the base housing 220 to the lock body 296. That is, the wiring conductor 77 extends from the keypad 275 in the base housing 220 to the lock body 296 disposed in the lower assembly 218. The wiring conductor is of sufficient length and gage and has a suitable conductor to transmit signals from the keypad 275 to the lock body 296 in the lower locking mechanism 280 to activate and deactivate the locking mechanism 280 disposed in the lower assembly 218. It is also to be understood that the signals can be transmitted wirelessly from the keypad 275 to the lock body 296, or from a mobile device to the lock body 296.

When the sear hub 290 is unlocked by the sear lock 300, the rotatable housing 230 is allowed to rotate into an open unlocked position such as shown in FIG. 35. As shown, the sear lock 300 is unlocked from the sear hub 290 when the lock nose 297 is actuated to retract back into the lock body 296 and the nose 300a of the sear lock 300 is retracted from within the notched indentation 290a in the sear hub 290. When the sear hub 290 is unlocked, the entire rotatable housing 230 is allowed to rotate as depicted in FIG. 51. As shown in FIG. 35, the first vertical frame member 241 and the second vertical frame member 242 are rotated 180 degrees from their initial closed position shown in FIG. 34.

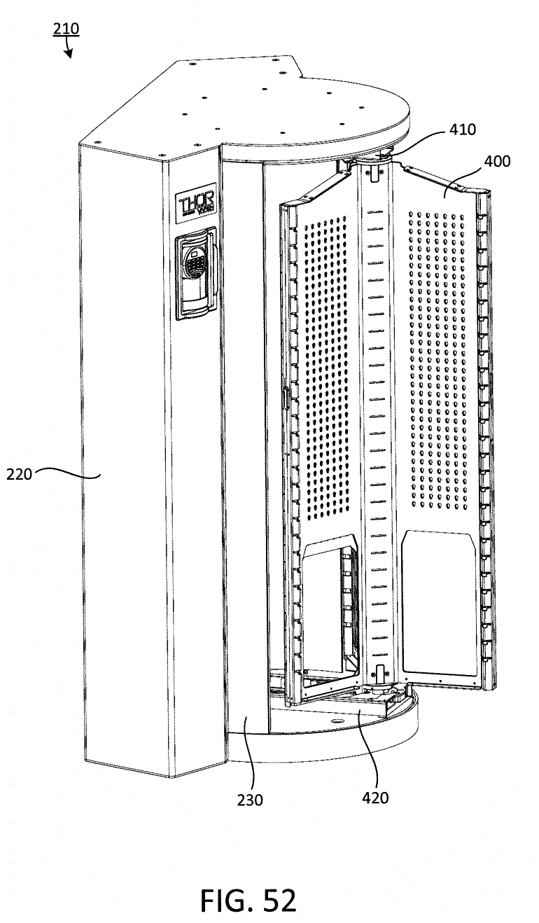

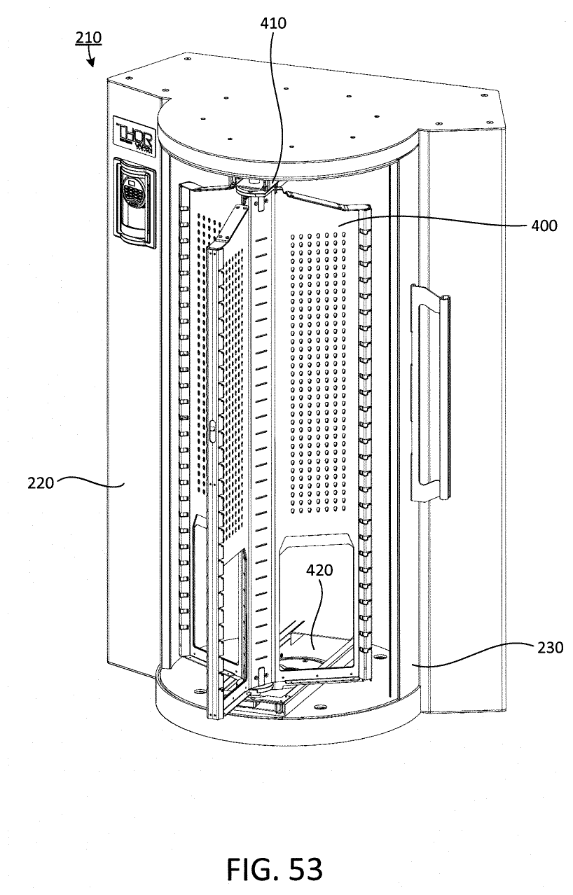

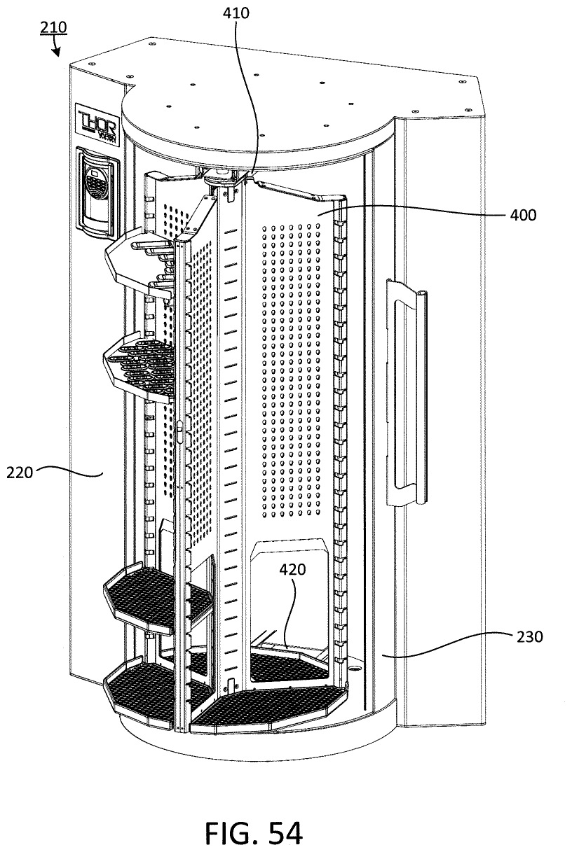

FIGS. 52-60 illustrate another aspect of this subject disclosure is to permit the outward extension of a rack assembly 400 from the internal compartment 234. The rack assembly 400 may be constructed for various applications. For example, the rack assembly 400 may be for jewelry or other valuable items. For brevity and exemplary purpose, the rack assembly 400 is a weapons rack 245.

FIG. 55 depicts an exemplary rack assembly 400. The rack assembly 400 is comprised of rack post 402 or shaft bounded on top end by an upper connection 404 and a bottom connection 406. A storage unit 401 is attached to the rack post 402. The upper connection 404 and the bottom connections 406 are capable of traveling within an upper track 410, and a lower track 420, respectively. Likewise, the upper connection 404 and the bottom connections 406 are capable of rotating to cause the storage unit 401 to be rotated.

The weight of the storage unit 401 stocked with items is supported by the upper end of the rack post 402 and the upper connection 404 disposed in the upper track 410 attached to the upper rack plate 412. The lower connection 406 may be constructed to merely slide within the lower track 420 without bearing the majority of the weight of the storage unit 401. According to this example, the upper rack plate 412 bears the majority of the weight and the rotatable housing 239 does not. The lower track 420 is fixed to the lower door plate 310 such that as the rotating door 230 rotates between 180 degrees, the lower track 420 also rotates. Alternatively, the lower track 420 can be constructed so that it is fixed in position and also does not rotate.

The advantage of this construction is that once the rotating door 230 has been opened and the internal compartment 234 is exposed, the storage unit 401 can be extended outward from within the internal compartment 234 along the tracks 410, 420 away from the base housing 220.

As shown in FIG. 55, the upper track 410 is attached to an upper rack plate 412. The upper rack plate 412 is fixed to the top assembly 216 (FIG. 35) and does not rotate when the rotatable housing 230 is moved between the open and closed position. FIGS. 55-57 show various bearings 414 attached to the upper rack plate 412 adjacent to its periphery. In assembly, the upper door plate 272 of the rotatable housing 230 is captured by the upper rack plate 412 of the rack assembly 400 and rotates on the bearings 414 as it moved between the open and closed positions. That is, the rotatable housing 230 is suspended by the connection between the upper door plate 272 and the upper rack plate 412. The upper door plate 272 rotates on the bearings 414.

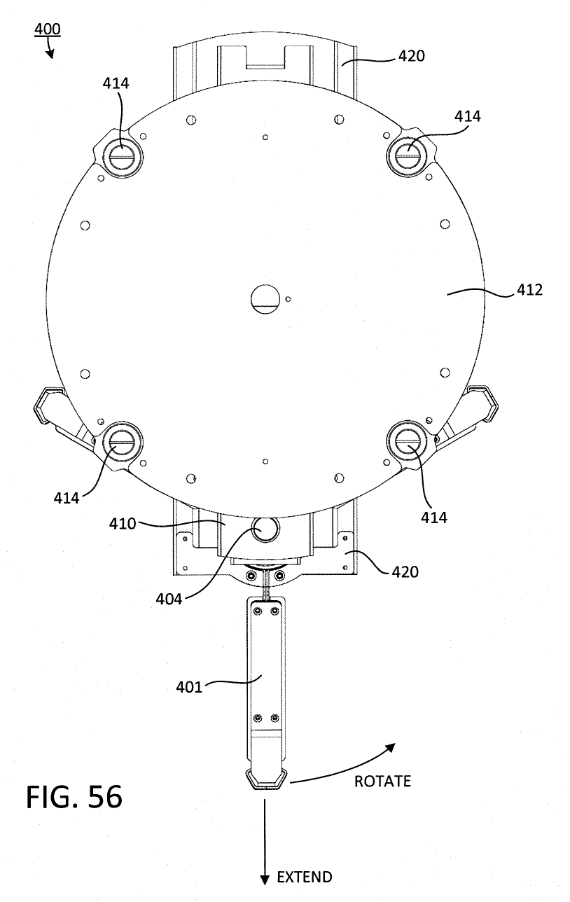

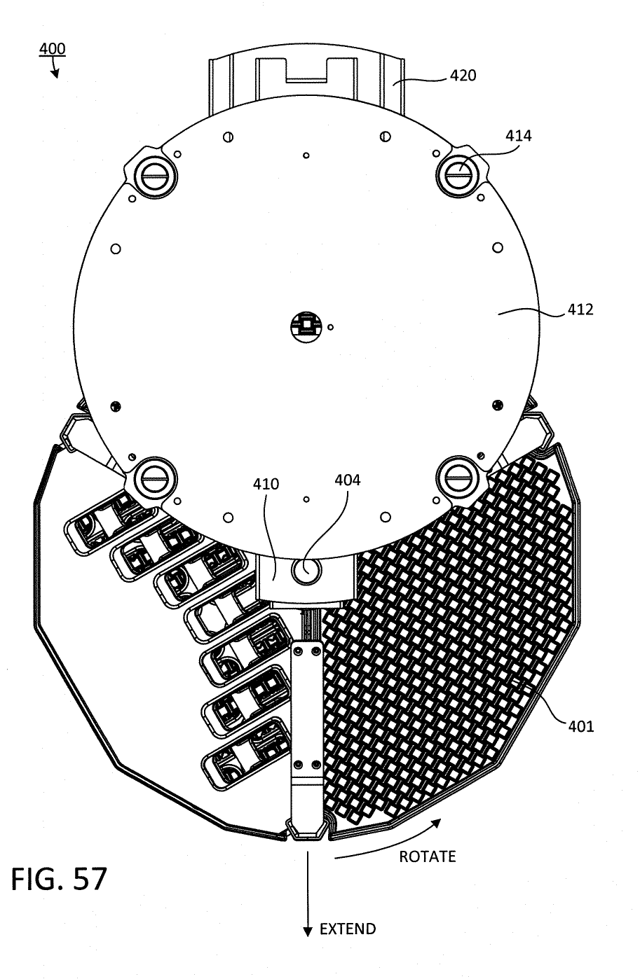

FIGS. 56-59 show that the rack assembly 400 can be constructed to rotate once the weapons rack 245 has been extended from within internal compartment 234 of the storage system 210. FIGS. 56-57 show a top view of the storage unit 401 (with shelves (FIG. 57) and without shelves (FIG. 56) in the rack assembly 400 in an extended position. That is, the upper connection 404 disposed in the upper track 410 is shown having traveled along the upper track 410 to an extended position away from the internal compartment 234 of the storage system 210. In this extended position, the upper connection 404 may be disengaged from a non-rotation structure in the upper track 410, and the upper connection and the storage unit 401 are then allowed to rotate. It is to be understood that a non-rotation structure may be embedded within the lower track 420.

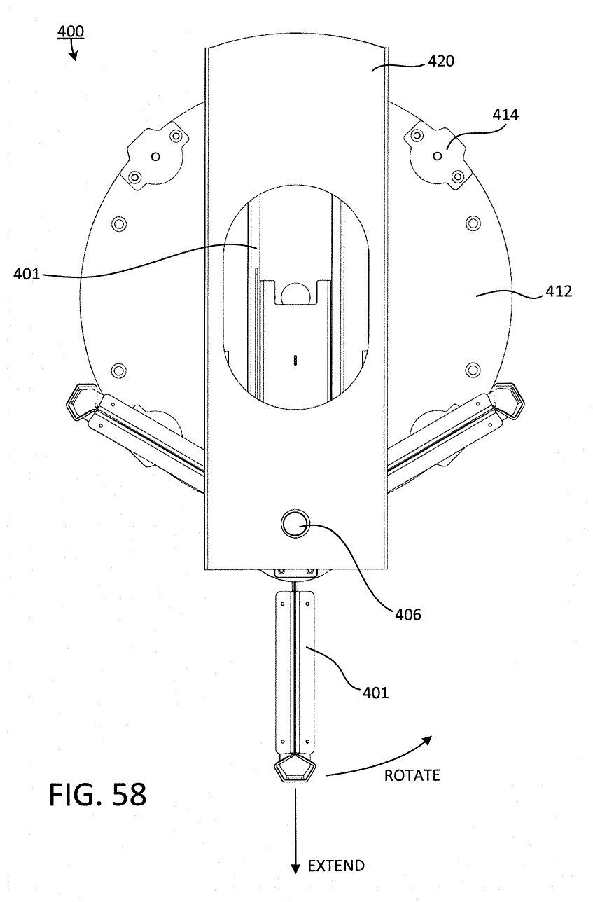

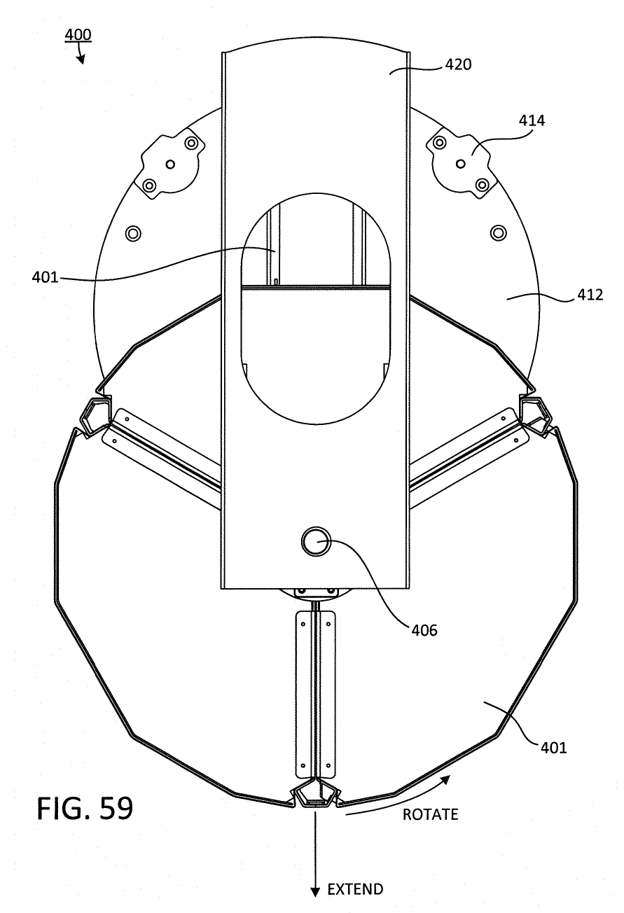

FIGS. 58-59 show a bottom view of the storage unit 401 (with shelves (FIG. 57) and without shelves (FIG. 56) in the rack assembly 400 in an extended position. That is, the lower connection 406 disposed in the lower track 420 is shown having traveled along the lower track 420 to an extended position away from the internal compartment 234 of the storage system 210. In this extended position, the lower connection 406 and the storage unit 401 are then allowed to rotate. The advantage of allowing the rotation in the extended position is to allow a user to quickly rotate the storage unit 401 and have access to all area of the storage unit 401 in a quick manner. This is particularly useful when the storage unit is a weapons rack 245 and various weapons must be accessed very quickly.

The illustrations and examples provided herein are for explanatory purposes and are not intended to limit the scope of the appended claims. It will be recognized by those skilled in the art that changes or modifications may be made to the above described embodiment without departing from the broad inventive concepts of the invention.

For example, the locking mechanism may be used for a variety of different applications outside of the weapons storage system technology, such as for example for use with secure enclosures for jewelry, currency and/or other personal effects. It is understood therefore that the invention is not limited to the particular embodiment which is described, but is intended to cover all modifications and changes within the scope and spirit of the invention.

What is claimed:

1. A storage system comprising:
an outer housing assembly comprising:
an elongated housing having a non-rotatable curved inner structure;
a top assembly attached to an upper end of the elongated housing, and a lower assembly attached to a lower end of the elongated housing; and
an arcuate housing door that rotates within the top assembly and the lower assembly concentrically about a longitudinal axis and partially within and adjacent to the non-rotatable curved inner structure, wherein an upper end of the arcuate housing door rotates around a circular plate attached to the top assembly about the longitudinal axis between:
a closed position that prevents access to an internal compartment within the elongated housing; and
an open position that provides an access opening of approximately 180 degrees about the longitudinal axis into the internal compartment within the elongated housing.

2. The storage system recited in claim 1, wherein the arcuate housing door has an upper door plate and a lower door plate, the upper door plate rotating on a bearing attached to the circular plate.

3. The storage system recited in claim 1, wherein the circular plate has an upper track attached to receive a storage unit that travels along the upper track.

4. The storage system recited in claim 3, wherein the storage unit travels outward of the internal compartment along the upper track when the arcuate housing door has been rotated into the open position.

5. The storage system recited in claim 3, wherein the storage unit is adapted to rotate when the storage unit has traveled outward of the internal compartment along the upper track.

6. The storage system recited in claim 3, wherein the storage unit further comprises:
a post having an upper connection attached to a first end and a lower connection attached to a second end,
wherein the upper connection travels outward of the internal compartment along the upper track, and the lower connection travels in a lower track outward of the internal compartment when the arcuate housing door has been rotated into the open position.

7. The storage system recited in claim 6, wherein the storage unit is a rack attached to the post adapted to receive various weapons.

8. The storage system recited in claim 3, wherein the storage unit is a rack, wherein when the arcuate housing door is rotated between the closed position and the open position, the rack remains fixed and does not rotate within the internal compartment of the elongated housing, where in the open position, the rack can extend outward from the internal compartment along the upper track, and when the rack has traveled to an outermost end of the upper track, an anti-rotation element is disengaged and the rack is allowed to rotate.

9. The storage system recited in claim 1, wherein the lower assembly further comprises a leveling assembly comprising:
a lower brace attached within the lower assembly;
a lower base plate adjustably attached to the lower brace; and
an adjustable fastener disposed between the lower brace and the lower base plate that is adjustably shortened or lengthened to move the lower base closer to, or further from the lower brace.

10. The storage system recited in claim 1, wherein the elongated housing further comprises:
a handle connected to the arcuate housing door that rotates the arcuate housing door between the closed position and the open position adjacent to the non-rotatable curved inner structure of the elongated housing.

11. The storage system recited in claim 1, further comprising:
a locking mechanism attached to the arcuate housing door adapted to prevent rotation or permit rotation of the arcuate housing door in a locked position or an unlocked position respectively, where, in the locked position, the locking mechanism prevents the arcuate housing door from rotating into the open position.

12. The storage system recited in claim 11, wherein the locking mechanism further comprises:
a door stop attached to the arcuate housing door;
a lock housing attached to the arcuate housing door, the lock housing securely enclosing:
a main shaft connected to a lower base plate that is fixed;
a sear hub having at least one notched indentation about its peripheral surface, the sear hub being concentrically fixed to the main shaft; and
at least one lock body attached to a sear lock having a nose end that engages and disengages the notched indentation in the sear hub to lock and unlock the locking mechanism respectively,
wherein when the arcuate housing door and the lock housing rotate between:
a locked position, when the arcuate housing door is closed and the door stop is butt up against a first stop lug; and
an unlocked position, when the arcuate housing door is rotated open approximately 180 degrees and the door stop is butt up against a second stop lug.

13. The storage system recited in claim 12, wherein two lock bodies are used in the lock housing.

14. The storage system recited in claim 12, wherein the lock body is an electronic actuated lock that is controlled by a keypad, wherein the keypad is located remote from the locking mechanism on the outer housing assembly.

15. The storage system recited in claim 1, wherein a locking mechanism is attached to the lower end of the arcuate housing door and positioned in the lower assembly within the elongated housing, the locking mechanism being bounded by a lower door plate of the arcuate housing door and a center platform in a lower brace provided at a bottom of the elongated housing.

16. A storage system comprising:
an outer housing assembly comprising:
an elongated housing having a non-rotatable curved inner structure;
a top assembly attached to an upper end of the elongated housing, and a lower assembly attached to a lower end of the elongated housing; and
an arcuate housing door attached to an upper door plate and a lower door plate, the arcuate housing door is bounded by, and rotates within the top assembly and the lower assembly concentrically about a longitudinal axis and partially within and adjacent to the non-rotatable curved inner structure, wherein the upper door plate of the arcuate housing door rotates suspended on a circular plate attached to the top assembly about the longitudinal axis between:
a closed position that prevents access to an internal compartment within the elongated housing; and
an open position that provides an access opening of approximately 180 degrees about the longitudinal axis into the internal compartment within the elongated housing.

17. The storage system recited in claim 16, wherein an upper track is attached to the circular plate, wherein when the arcuate housing door is rotated between the closed position and the open position, a rack attached to the upper track remains fixed and does not rotate within the internal compartment of the elongated housing, where in the open position, the rack can extend outward from the internal compartment along the upper track, and when the rack has traveled to an outermost end of the upper track, an anti-rotation element is disengaged and the rack is allowed to rotate.

18. A storage system comprising:
an outer housing assembly comprising:
an elongated housing having a non-rotatable curved inner structure;
a top assembly attached to an upper end of the elongated housing, and a lower assembly attached to a lower end of the elongated housing; and
an arcuate housing door attached to an upper door plate and a lower door plate, the arcuate housing door is bounded by, and rotates within the top assembly and the lower assembly concentrically about a longitudinal axis and partially within and adjacent to the non-rotatable curved inner structure, wherein the upper door plate of the arcuate housing door rotates suspended on a circular plate attached to the top assembly about the longitudinal axis between:
a closed position that prevents access to an internal compartment within the elongated housing; and
an open position that provides an access opening of approximately 180 degrees about the longitudinal axis into the internal compartment within the elongated housing; and
a leveling assembly disposed in the lower assembly of the elongated housing that adjustably shortens or lengthens a height adjustable lower base in the lower assembly.

19. The storage system recited in claim 18, further comprising:
a locking mechanism attached to the arcuate housing door adapted to prevent rotation or permit rotation of the arcuate housing door in a locked position or an unlocked position respectively, where, in the locked position, the locking mechanism prevents the arcuate housing door from rotating into the open position.

20. The storage system recited in claim 18, wherein an upper track is attached to the circular plate, wherein when the arcuate housing door is rotated between the closed position and the open position, a rack attached to the upper track remains fixed and does not rotate within the internal compartment of the elongated housing, where in the open position, the rack can extend outward from the internal compartment along the upper track, and when the rack has traveled to an outermost end of the upper track, an anti-rotation element is disengaged and the rack is allowed to rotate.
